(19) United States
(12) Patent Application Publication
(10) Pub. No.: US 2012/0162365 A1
(43) Pub. Date: Jun. 28, 2012

(54) RECEIVER

(76) Inventors: Masayoshi MIURA, Kawasaki (JP); Sadao Tsuruga, Yokohama (JP); Takashi Kanemaru, Yokohama (JP); Satoshi Otsuka, Yokohama (JP)

(21) Appl. No.: 13/307,071

(22) Filed: Nov. 30, 2011

(30) Foreign Application Priority Data
Dec. 24, 2010 (JP) 2010-286913

(51) Int. Cl. H04N 13/00

(52) U.S. Cl. 348/43; 348/E13.068

(57) ABSTRACT

The receiver includes a receiver unit that receives a digital broadcasting signal with contents that includes a video signal and identifier information indicating that the video signal includes a 3D video signal, a conversion unit which converts the 3D video signal into a 2D video signal, a rewriting unit which rewrites or deletes the identifier information, and a recording unit capable of recording the contents contained in the digital broadcasting signal received by the receiver unit in a recording medium. The conversion unit converts the 3D video signal of the contents into the 2D video signal. The rewriting unit rewrites the identifier information of the contents when recording the contents in the recording medium.

### CLAIM OF PRIORITY

The present application claims priority from Japanese patent application serial no. JP 2010-286913, filed on Dec. 24, 2010, the content of which is hereby incorporated by reference into this application.

### BACKGROUND OF THE INVENTION

(1) Field of the Invention

The present invention relates to a video signal processing.

(2) Description of the Related Art

Japanese Unexamined Patent Application Publication No. 2003-9033 discloses a digital broadcast receiver which actively notifies a user about start of a program desired by the user on a certain channel (see paragraph [0005]), and is provided with a unit which takes out program information contained in a digital broadcasting wave and uses selection information registered by the user to select a notification object program, and a unit which interrupts the currently displayed screen with the message notifying the selected notification object program (see paragraph [0006]).

### SUMMARY OF THE INVENTION

Japanese Unexamined Patent Application Publication No. 2003-9033 does not disclose the mechanism for receiving and allowing the user to view the broadcast to which information (3D identifier) indicating 3D contents has been added. The disclosed structure is not able to identify whether the currently received broadcast or the one that is planned to be received is the 3D program, thus failing to appropriately execute the process based on the 3D identifier when recording, reproducing the received contents or distributing them to the other device.

In view of the aforementioned problem, the present invention provides the receiver which includes a receiver unit that receives a digital broadcasting signal with contents that includes a video signal and identifier information indicating that the video signal includes a 3D video signal, a conversion unit which converts the 3D video signal into a 2D video signal, a rewriting unit which rewrites or deletes the identifier information, and a recording unit capable of recording the contents contained in the digital broadcasting signal received by the receiver unit in a recording medium. The conversion unit converts the 3D video signal of the contents into the 2D video signal. The rewriting unit rewrites the identifier information of the contents when recording the contents in the recording medium.

According to the mechanism as described above, the contents may be appropriately processed based on the 3D identifier when recording and reproducing the received contents, or distributing them to the other device, thus improving user convenience.

### BRIEF DESCRIPTION OF THE DRAWINGS

FIG. 1 shows an example of a block diagram of a system structure;

FIG. 2 shows an example illustrating a block diagram of a structure of a transmitter;

FIG. 3 shows an example of a screen displayed upon 2D conversion recording;

FIG. 4 shows an example of the screen displayed upon 2D conversion recording.

FIG. 5A shows an example of a data structure of the 3D identifier;

FIG. 5B shows an example of the data structure of the 3D identifier;

FIG. 5C shows an example of the data structure of the 3D identifier;

FIG. 5D shows an example of the data structure of the 3D identifier;

FIG. 6 shows an example of a concept with respect to 2D conversion of contents in SBS mode;

FIG. 7 shows an example of a process for executing 2D conversion of the contents in SBS mode;

FIG. 8 shows an example of a recording process according to Example 1;

FIG. 9 shows an example of a recording process according to Example 1;

FIG. 10 shows an example of a functional block inside a recording/reproducing device;

FIG. 11 shows an example of a recording process according to Example 1;

FIG. 12 shows an example of a recording process according to Example 1;

FIG. 13 shows an example of a structure of a receiver according to Example 1;

FIG. 14 shows an exemplary general functional block diagram inside the CPU of the receiver according to Example 1;

FIG. 15 shows an example of a block diagram illustrating an exemplary structure of a system;

FIG. 16 shows an example of a block diagram illustrating an exemplary structure of a system;

FIGS. 17A and 17B are views explaining 3D reproduction/output/display of the 3D contents;

FIG. 18 shows an example of a network connection configuration upon distribution according to Example 2;

FIG. 19 shows an example of a structure of a receiver according to Example 2;

FIG. 20 shows an example of a functional block diagram inside a distribution control unit;

FIG. 21 shows an example of a distribution process according to Example 2;

FIG. 22 shows an example of a screen displaying setting with respect to execution of the 2D conversion distribution;

FIG. 23 shows an example of a process for determining availability of the 2D conversion distribution according to Example 2;

FIG. 24 shows an example of connection configuration to an external recording device according to Example 3;

FIG. 25 shows an example of a structure of a receiver according to Example 3;

FIG. 26 shows an example of a functional block diagram inside a recording/reproducing unit according to Example 3;

FIG. 27 shows an example of a recording process according to Example 3;

FIG. 28 shows an example of a screen displaying setting with respect to execution of the 2D conversion recording simultaneously with recording of the 3D contents;

FIG. 29 shows an example of a process for executing 2D conversion of contents in TAB mode;

FIG. 30 shows an example of a process for executing 2D conversion of contents in 2-viewpoint classified ES transmission mode; and

FIG. 31 shows an example of a process for executing 2D conversion display at a receiver B (distribution destination).

### DETAILED DESCRIPTION OF THE EMBODIMENT

Preferred examples of the present invention will be described hereinafter. It is to be understood that the invention is not limited to those examples. The examples will be described mainly with respect to the receiver as a preferred mode. However, it may also be applied to the device other than the receiver as well. All the structures of the example do not have to be adopted, but may be selectively employed.

In the following description, each term of “3D” and “2D” denotes “three dimensional” and “two dimensional”, respectively. For example, the 3D image represents the one which allows the viewer to perceive that an object of such image exists sterically in the same space as that of the viewer by presenting parallax images to left and right eyes of the viewer. The term “3D contents” represents those with video signals capable of displaying the 3D video images through the process executed by the display device.

There are various types of method for displaying the 3D video images, for example, anaglyph method, polarization display method, frame sequential method, parallax barrier method, lenticular lens method, microlens array method, and integral imaging method.

With the anaglyph method, images picked up from left and right sides at different angles are reproduced while being superimposed with red and blue colors, respectively so as to be viewed by the viewer who wears a pair of glasses having right and left sides provided with red and blue color filters, respectively (hereinafter referred to as “anaglyph glasses”).

With the polarization display method, left and right images are linearly polarized in a perpendicular direction while being superimposed and projected so as to be separated with the glasses with a polarization filter (hereinafter referred to as “polarized glasses”).

With the frame sequential method, the images picked up from left and right sides at different angles are reproduced alternately so as to be viewed with glasses with a shutter which shuts the left and right views (fields of view) alternately (hereinafter referred to as “shutter glasses” not necessarily in the form of glasses so long as it is formed as the device with electrical characteristic capable of controlling light transmission of the element inside the lens).

With the parallax barrier method, a vertically striped barrier so called “parallax barrier” is superimposed on the display so as to allow the right eye and the left eye to view the images for the right eye and the left eye, respectively. This method does not require the user to wear the special glasses. Use of the parallax barrier method may be classified as the 2-viewpoint classified method with relatively narrower viewing position, or a multi-viewpoint classified method with relatively broader viewing position.

With the lenticular lens method, the lenticular lens is superimposed on the display so that the right-eye image and the left-eye image may be viewed by the right and left eyes, respectively. The user does not have to wear the special glasses. The lenticular lens method may be classified as the 2-viewpoint method with relatively narrower viewing position or the multi-viewpoint method with relatively broader viewing position in a lateral direction.

With the microlens array method, the microlens array is superimposed on the display so that the right-eye image and the left-eye image are viewed by the right and left eyes, respectively, which does not require the user to wear the special glasses. The microlens array method is the multi-viewpoint method with relatively broader viewing position both in vertical and lateral directions.

With the integral imaging method, the wave front of the light ray is reproduced so that the parallax image is presented to the viewer who is not required to wear the special glasses and the like. The viewing position is relatively broad.

The aforementioned methods for displaying the 3D video images are mere examples, and accordingly, the method other than those described above may be employed. The tool or device required for viewing the 3D images, for example, the anaglyph glasses, polarization glasses, shutter glasses and the like may be called “3D glasses” or “3D viewing aid device”.

<System>

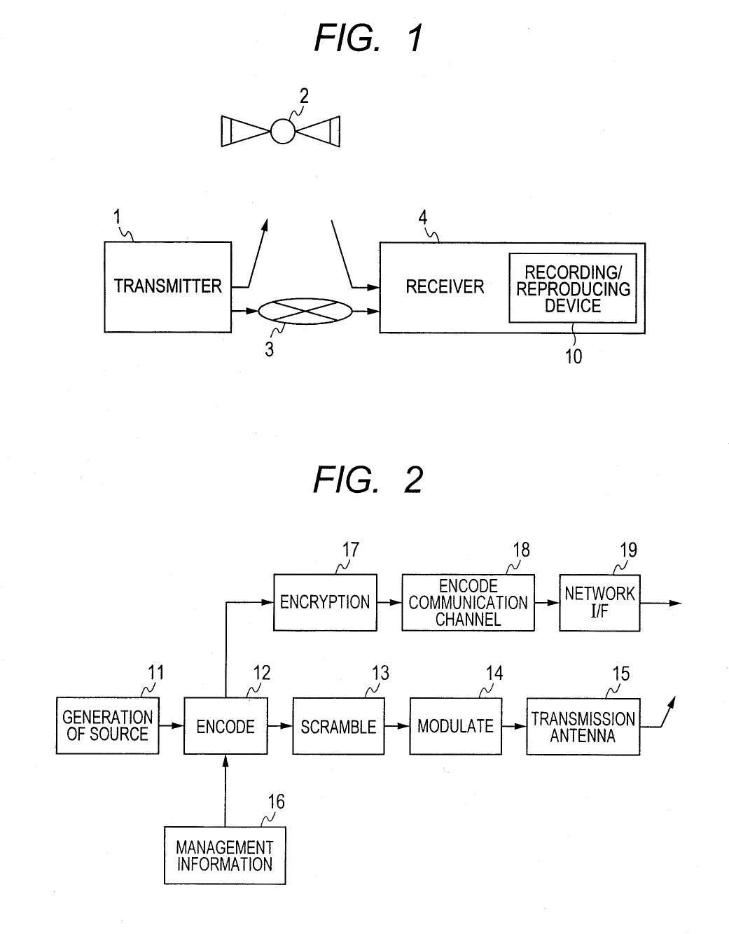

FIG. 1 is a block diagram showing an exemplary structure of the system according to the example in the case where the information transmitted/received through the broadcasting is recorded and reproduced. The information does not have to be derived from the broadcasting, but may be derived from VOD (Video On Demand) through communication, which will be referred to as distribution.

FIG. 1 shows a transmitter 1 provided in an information service station such as a broadcast station, a relay device 2 provided in a relay station or a broadcast satellite, a public line network 3 for connecting ordinary households to the broadcast station like internet, a receiver 4 provided in a user's house, and a recording/reproducing device (a reception recording/reproducing unit) 10 which is built in the receiver 4. The recording/reproducing device 10 is capable of recording and reproducing the broadcasted information, and reproducing the contents from the removable external medium.

The transmitter 1 transmits the signal wave modulated via the relay device 2. As the drawing shows, the signal wave may be transmitted via the cable, telephone line, terrestrial broadcast, and network such as internet through the public line network 3 other than the satellite. The signal wave received by the receiver 4 is demodulated into an information signal, and recorded in the recording medium as necessary as described later. When the signal wave is transmitted via the public line network 3, it is converted into the data format (IP packet) in accordance with the protocol (for example, TCP/IP) adapted for the public line network 3. The receiver 4 decodes the received data into the information signal which is adapted for recording as necessary so as to be recorded in the recording medium. The user is allowed to view video images/sounds indicated by the information signal on the display built in the receiver 4, or on the display (not shown) that is not built in the receiver but connected to the receiver 4.

<Transmitter>

FIG. 2 is a block diagram showing an exemplary structure of the transmitter 1, illustrating a source generation unit 11, an encoder unit 12 which compresses data using MPEG2 or H.264 method for adding the program information, a scrambler 13, a modulator 14, a transmission antenna 15, and a management information adding unit 16. The audio visual information generated by the source generation unit 11 formed of a camera, recording/reproducing device and the like has data size compressed by the encoder unit 12 so as to execute transmission with less occupied band. The data are subjected to transmission encryption in the scrambler 13 as necessary so as to allow specific audience to view the image. The data are further modulated into the signal adapted for transmission in the modulator 14, for example, OFDM, TC8PSK, QPSK, and multiple-value QAM, and transmitted as electric wave from the transmission antenna 15 to the relay device 2. Program specific information such as property of the contents created by the source generation unit 11 (for example, encoded audio visual information, encoded audio information, program structure, whether 3D image or not) is added to the management information adding unit 16 as well as the program array information prepared by the broadcast station (for example, structure of the current program or the next program, service format, and structure information of the programs corresponding to 1 week). The aforementioned program specific information and the program array information will be referred to as program information hereinafter.

In most of the cases, a single electric wave contains a plurality of information data multiplexed using such method as time division and spectral spread. In such a case, there are a plurality of systems of the source generation units 11 and the encoder units 12 (not shown) which have a multiplexing unit (multiplexer) for multiplexing a plurality of information data therebetween.

Likewise, for the signal transmitted via the public line network 3, the signal generated by the encoder unit 12 is encrypted by an encryption unit 17 as necessary so as to be viewable for the specific audience. It is encoded by a communication encoding unit 18 into the signal adapted for transmission through the public line network 3, and then transmitted from a network I/F (Interface) unit 19 to the public line network 3.

<3D Transmission Method>

The method for transmitting the 3D program from the transmitter 1 has two types. With one type, two images for left and right eyes are arranged on a single screen through the broadcast method for the existing 2D program. This method uses the existing MPEG2 (Moving Picture Experts Group 2) and H.264 AVC as the video compression method, which is compatible with the existing broadcast and capable of using the existing relay infrastructure. So this method allows the existing receiver (STB) to receive the data. However, this method results in the 3D video image transmission with resolution half the maximum resolution of the existing broadcast (vertical or horizontal direction).

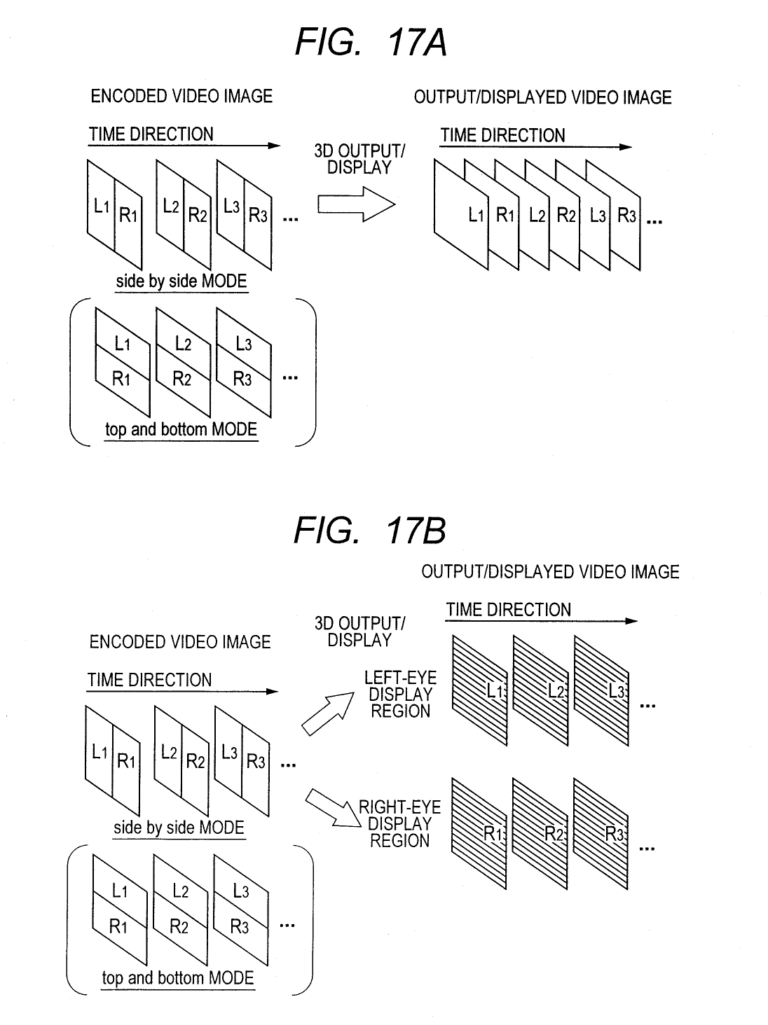

FIG. 17A shows a “Side-by-Side” mode (hereinafter referred to as SBS) in which the single screen is divided into two left and right sections arranged for a left-eye image (L) and a right-eye image (R), each having a width in a horizontal direction substantially half the width of the 2D program, and a width in a vertical direction the same as that of the 2D program, and a “Top-and-Bottom” method (hereinafter referred to as TAB) in which the single screen is divided into two top and bottom sections arranged for the left-eye image (L) and the right-eye image (R), each having the width in a horizontal direction the same as that of the 2D program, and the width in a vertical direction substantially half the width of the 2D program. Additionally, there are “Field alternative” method for arranging the parts using interlace, “Line alternative” method for arranging the left-eye images and the right-eye images alternately for each scanning line, and “Left+Depth” method for storing the 2D (one side) video and the depth information (the distance to the object) for each pixel of the audio visual image.

Each of the aforementioned methods divides the single image into a plurality of images so that images with multiple viewpoints are stored, which allows use of MPEG2 and H.264 AVC (except MVC) that are not the multi-view video encoding method. This makes it possible to allow execution of the 3D program broadcast using the existing 2D program broadcasting method. Assuming that the 2D program is allowed to be transmitted having the screen size formed of 1902 dots in the maximum horizontal direction, and 1080 lines in the vertical direction, and the 3D program broadcasting is executed in the SBS mode, the single screen is divided into left and right sections so that each of the left-eye image (L) and the right-eye image (R) is transmitted as the image size with 906 dots in the horizontal direction and 1080 lines in the vertical direction. With the 3D program broadcasting in TAB mode, the single screen is separated into top and down sections so that each of the left-eye image (L) and the right-eye image (R) is transmitted as the image size with 1920 dots in the horizontal direction and 540 lines in the vertical direction.

There is a method for transmitting the left-eye image and the right-eye image via the respective streams, for example, the transmission method using H.264 MVC as the multi-view video encoding method. The method is allowed to transmit the 3D video image with high resolution compared to the SBS mode and the TAB mode.

The multi-viewpoint image encoding method as the standardized encoding method in order to encode the multi-view image is capable of encoding the multi-viewpoint image without dividing the single image into sections for the respective viewpoints, thus encoding the different image for each viewpoint.

The 3D video image may be transmitted using the aforementioned method by transmitting the encoded image of the left-eye viewpoint set as the main view image, and the encoded image of the right-eye viewpoint set as the other view image. This makes it possible to allow the main view image to be compatible with the existing 2D program broadcasting method. Assuming that H.264 MVC is used as the multi-viewpoint image encoding method, the main viewpoint image may be kept compatible with the 2D image of the H.264 AVC in the base sub-stream of H.264 MVC. This makes it possible to display the main viewpoint image as the 2D image. In this example, the aforementioned method will be referred to as “3D 2-viewpoint classified ES transmission” (“ES” stands for Elementary Stream).

There is another example of the “3D 2-viewpoint classified ES transmission method” which has the encoded image for a left eye set as the main viewpoint image so as to be encoded with the MPEG2 and the encoded image for a right eye set as the other viewpoint image so as to be encoded with H.264 AVC on the respective streams. This method allows the main viewpoint image to be compatible with the MPEG2 so as to be displayed as the 2D image. This makes it possible to keep it compatible with the existing 2D program broadcasting method having the encoded image using the MPEG2 widely distributed.

There is another example of the “3D 2-viewpoint classified ES transmission method” which has the encoded image for a left eye set as the main viewpoint image so as to be encoded with the MPEG2 and the encoded image for a right eye set as the other viewpoint image so as to be encoded with the MPEG2 on the respective streams. This method allows the main viewpoint image to be compatible with the MPEG2 so as to be displayed as the 2D image. This makes it possible to keep it compatible with the existing 2D program broadcasting method having the encoded image using the MPEG2 widely distributed.

With another example of the “3D 2-viewpoint classified ES transmission method”, the left-eye encoded image is set as the main viewpoint image so as to be further encoded with H.264 AVC or H.264MVC, and the right-eye encoded image is set as the other viewpoint image so as to be further encoded with the MPEG2.

Besides the “3D 2-viewpoint classified ES transmission method”, the encoding method such as MPEG2 and H.264 AVC (other than MVC), which is not the encoding method that has been originally specified as the multi-viewpoint video image encoding method is capable of transmitting the 3D video signal by generating streams that store the left-eye video image and the right-eye frame alternately.

<Program Information>

The program information includes the program-specific information and the program array information. The program-specific information or PSI is specified by the MPEG2 system standard, and is formed of four tables including a PAT (Program Association Table) as the information required for selecting the desired program, which designates a packet identifier for TS packet that transmits a PMT (Program Map Table) relevant to the broadcasting program, the PMT that designates the packet identifier for the TS packet that transmits the respective encoded signals that form the broadcasting program and the packet identifier for the TS packet that transmits the common information among the information data relevant to the pay broadcasting, an NIT (Network Information Table) that transmits the information for correlating the transmission channel information such as modulation frequency with the broadcasting program, and a CAT (Conditional Access Table) that designates the packet identifier for the TS packet that transmits the individual information among the relevant information relevant to the pay broadcasting. The aforementioned information includes the video image encoded information, the audio encoded information and program configuration. According to the present invention, the information with respect to 3D video image is further contained. The PSI is added by the management information adding unit 16.

The program arrangement information or SI (Service Information) is a variety of information specified for convenience of the program selection, and includes the PSI information of the MPEG-2 system standard, for example, EIT (Event Information Table) to which the information relevant to the program is written, for example, program title, broadcasting date, and the program content, and SDT (Service Description Table) which contains the information relevant to the organization channel (service) such as the organization channel name, and name of the broadcaster.

For example, the information that indicates the one with respect to configuration of the program that has been currently broadcasted or will be broadcasted next, service type, and the one indicating the week-long program configuration information is contained, and added by the management information adding unit 16.

Selective use of the table between the PMT and EIT will be described. As the PMT has the information about the currently broadcasted program only, and accordingly, it is impossible to confirm with respect to the information about the program scheduled to be broadcasted in future. However, it has the short transmission cycle from the transmission side. So the time taken until completion of the reception is short. The unchanged information of the currently broadcasted program may provide advantage of high reliability. Meanwhile, for the EIT (Schedule basic/schedule extended), the information up to 7 days in advance may be obtained besides the currently broadcasted program. However, as the transmission cycle from the transmission side is longer than that of the PMT, resulting in the longer time taken until the completion of reception compared to the PMT. This may require more data storage areas to be retained. The information may be changed for the future event, resulting in disadvantage such as low reliability.

<Hardware Structure of Receiver>

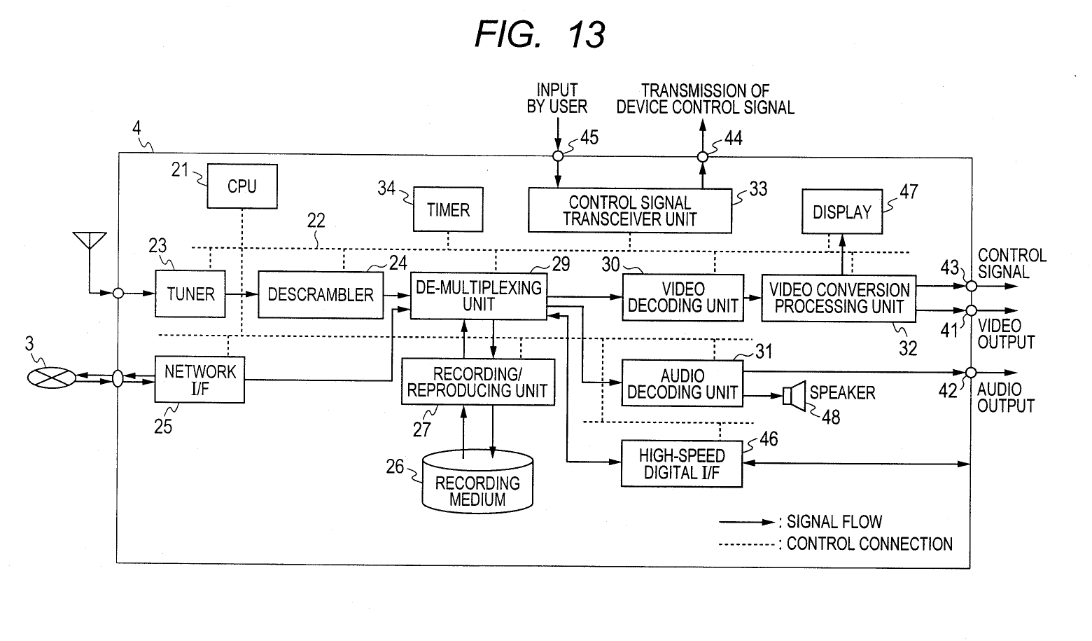

FIG. 13 shows a hardware structure as an exemplary structure of the receiver 4 of the system shown in FIG. 1. Referring to the drawing, a CPU (Central Processing Unit) 21 for generally controlling the receiver and a general path 22 for controlling the CPU 21 and the inside of the receiver, and transmitting the information are provided.

A tuner 23 receives the broadcasting signal transmitted from the transmitter 1 wirelessly (satellite, terrestrial) or via a broadcasting transmission network such as the cable, and executes selection of the specific frequency, demodulation, and error correction so as to output the multiplexed packet such as the MPEG2-Transport Stream (hereinafter referred to as “TS”).

A descrambler 24 decodes the scramble executed by the scrambler 13. A network I/F (Interface) for transmission and reception of information with the network so as to allow transmission and reception of a variety of information and the MPEG2-TS between the internet and the receiver.

A recording medium 26 may be a HDD (Hard Disk Drive) and a flash memory which are built in the receiver 4, for example, or a HDD, a disk type recording medium, a flash memory which are of removable type. A recording/reproducing unit 27 controls the recording medium 26 and further recording of the signal to the recording medium 26 and reproduction of the signal therefrom.

A de-multiplexing unit 29 separates the signal multiplexed in the format with MPEG2-TS into signals corresponding to the video ES (Elementary Stream), the audio ES, and the program information. The ES denotes the respective images and the audio data subjected to compression and encoding.

A video decoding unit 30 decodes the video ES to the video signal. An audio decoding unit 31 decodes the audio ES to the audio signal so as to be output to a speaker 48, or output from the audio output 42.

A video conversion processing unit 32 executes conversion of the video signal decoded by the video decoding unit 30 through the process for converting the 3D or 2D video signal in accordance with instruction of the CPU, and superposition of the display such as the OSD (On Screen Display) generated by the CPU 21 on the video signal. The thus processed video signal is output to the display 47 or the video signal output unit 41 so that the synchronous signal and the control signal (used for device control) corresponding to the format of the processed video signal so as to be output from the video signal output unit 41 and the control signal output unit 43.

A control signal transceiver unit 33 receives input operated from the user operation input unit 45, (for example, the key code from the remote controller for sending the IR (Infrared Radiation) signal), and transmits the device control signal (IR) generated by the CPU 21 and the video conversion processing unit 32 from the device control signal transmitter 44 to the external device.

A timer 34 includes a counter for keeping up the current time. A high-speed digital I/F 46 such as the serial interface and the IP interface subjects the TS restructured by the de-multiplexing unit to the process requiring encryption so as to be externally output, and decodes the externally received TS so as to be input to the de-multiplexing unit 29.

A display 47 displays the 3D and 2D images decoded by the video decoding unit 30, which have the images converted by the video conversion processing unit 32. A speaker 48 outputs sounds based on the audio signal decoded by the voice decoding unit.

When displaying the 3D video image on the display, the synchronous signal and the control signal may be output from the control signal output unit 43 and the device control signal transmitter 44, if necessary, or the additional and exclusive signal output unit may be provided.

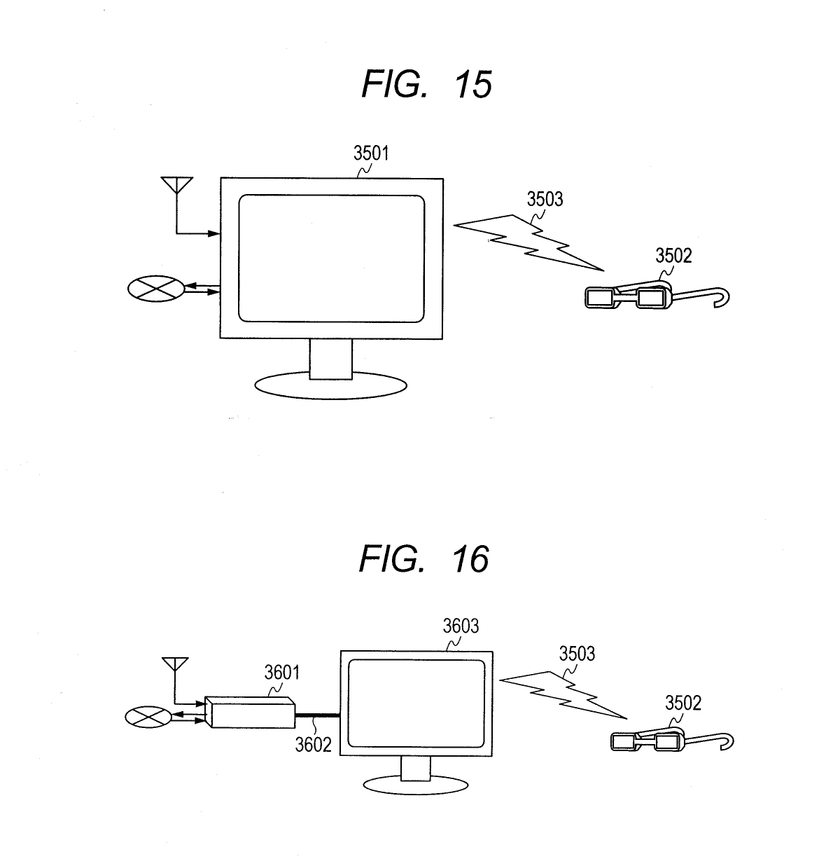

An example of the system structure which includes the receiver, the audio device and the 3D audio aid device (for example, 3D glasses) will be described referring to FIGS. 15 and 16. FIG. 15 shows a system structure having the receiver and the audio device combined. FIG. 16 shows an example that the receiver and the audio device are separated.

Referring to FIG. 15, a display device 3501 includes the structure of the receiver 4, and is capable of displaying the 3D video image and executing audio output. A control signal 3503 (for example, IR signal) for controlling the 3D viewing aid device is output from the display device 3501. There is a 3D viewing aide device 3502.

Referring to FIG. 15, the video signal is displayed on the video display of the display device 3501, and the audio signal is output from the speaker of the display device 3501. Likewise, the display device 3501 is provided with an output terminal that outputs a control signal for controlling the device control signal transmitter 44 or the 3D viewing aid device from the control signal output unit 43.

The aforementioned description is based on the premise that the display device 3501 and the 3D viewing aid device 3502 shown in FIG. 15 adopt the frame sequential method for displaying. In the case where those devices shown in FIG. 15 adopt the polarization display method, what the user needs are only the polarization glasses as the 3D viewing aid device 3502. So there is no need of the control signal 3503 output from the display device 3501 to the 3D viewing aid device 3502.

Referring to FIG. 16, a video audio output device 3601 includes the receiver 4. A transmission channel 3602 (for example, HDMI cable) transmits video/audio/control signals. A display 3603 displays and outputs the externally input video/audio signals.

In the aforementioned case, the video signal output from the video output unit 41 of the video audio output device 3601 (receiver 4), the audio signal output from the audio output unit 42, and the control signal output from the control signal output unit 43 are converted into transmission signals adapted for the format specified by the transmission channel 3602 (for example, format specified based on HDMI standard), and further input to the display 3603 via the transmission path 3602.

The display 3603 receives the transmission signals, and decodes those signals into the original video signal, audio signal and the control signal so that the video and audio outputs are executed, and the control signal 3503 for the 3D viewing aid device is output to the 3D viewing aid device 3502.

The above description is based on the premise that the display device 3603 and the 3D viewing aid device 3502 shown in FIG. 16 adopt the frame sequential method for displaying. In the case where those devices shown in FIG. 16 adopt the polarization display method, what the user needs are only the polarization glasses for the 3D viewing aid device 3502. So there is no need of outputting the control signal 3503 output from the display device 3603 to the 3D viewing aid device 3502.

The respective elements 21 to 46 shown in FIG. 13 may be partially formed of at least one LSI. The respective elements 21 to 46 shown in FIG. 13 may be partially realized by software.

<Functional Block Diagram of Receiver>

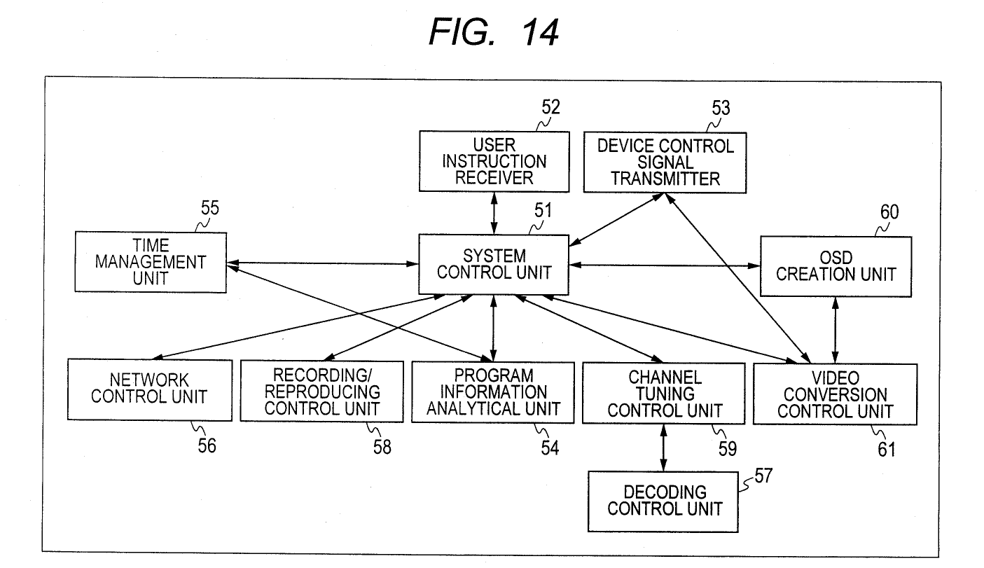

FIG. 14 shows an exemplary functional block diagram of the process executed in the CPU 21. The respective blocks are in the form of software modules executed by the CPU 21, for example, so that information/data communication, and control instruction are performed between the modules by performing a certain operation (message passing, function call, event transmission).

The respective modules execute transmission and reception of information via the general path 22 as well as each hardware inside the receiver 4. Lines (arrows) on the drawing represent correlation relevant for the description only. However, the process requiring communication tool and communication exists between other modules. For example, the channel tuning control unit 59 obtains the program information required for tuning the channel from the program information analyzing unit 54. Each function of the functional blocks will be described. The system control unit 51 manages each state of the respective modules, and the user instruction state, and sends instruction to the respective modules. A user instruction receiving unit 52 receives and interprets the input signal through user's operation, which is received by the control signal transceiving unit 33, and sends the user instruction to the system control unit 51.

The device control signal transmitter 53 instructs the control signal transceiving unit 33 to transmit the device control signal in accordance with the instructions from the system control unit 51 and the other module.

The program information analytical unit 54 analyzes contents of the program information obtained from the de-multiplexing unit 29, and supplies the required information to the respective modules. The time management unit 55 obtains time correction information (TOT: Time Offset Table) contained in the TS from the program information analytical unit 54 to manage the current time, and notifies alarm (incoming designated time) and one shot timer (elapse of predetermined time period) in response to the request of each module using the counter of the timer 34.

The network control unit 56 controls the network I/F 25, and obtains a variety of information and the TS from the specific URL (Unique Resource Locater) and specific IP (Internet Protocol) address. The decoding control unit 57 controls the video decoding unit 30 and the audio decoding unit 31 so as to start/stop the decoding and obtain the information contained in the stream.

The recording/reproducing control unit 58 controls the recording/reproducing unit 27 to read the signal based on the specific position of the specific contents from the recording medium 26 using the arbitrary reading format (normal reproduction, fast-forward, rewind, pause). It also controls the signal input to the recording/reproduction unit 27 so as to be recorded in the recording medium 26.

The channel tuning control unit 59 controls the tuner 23, descrambler 24, the de-multiplexing unit 29 and the decoding control unit 57 to receive the broadcasting and record the broadcasting signal. Alternatively, it executes reproduction from the recording medium and control until the video and audio signals are output. Specific broadcasting receiving operation, recording operation of the video signal, and reproducing operation from the recording medium will be described later.

An OSD creation unit 60 creates OSD data that contain specific messages, and instructs the video conversion control unit 61 to superimpose the created OSD data on the video image signal so as to be output. The request for 3D display is sent to the video conversion control unit 61 based on the OSD data for the left and right eyes to display 3D message.

The video conversion control unit 61 controls the video conversion processing unit 32 to superimpose the video image obtained by converting the video signal input from the video decoding signal unit 30 to the video conversion processing unit 32 into the 3D or 2D video image in accordance with the instruction from the system control unit 51 on the OSD input from the OSD creation unit 60. The video image is further processed (scaling, PinP, 3D display) so as to be displayed on the display 47 or externally output. Details of the method for converting the 3D, 2D video images into the predetermined format in the video conversion processing unit 32 will be described later. The respective functional blocks may provide the aforementioned functions.

<Reception of Broadcasting>

The control procedure and flow of signals for reception of broadcasting will be described. Upon reception of the instruction from the user, which indicates reception of broadcasting of the specific channel (CH)(for example, by depression of CH button on the remote control unit), the system control unit 51 instructs the channel tuning control unit 59 to select the channel to the CH (hereinafter referred to as the specified CH) designated by the user.

Upon reception of the instruction, the channel tuning control unit 59 instructs the tuner 23 with respect to receiving control of the designated CH (channel tuning to the designated frequency band, demodulation of the broadcasting signal, and error correction process) so as to output the TS to the descrambler 24.

Then the channel tuning control unit 59 instructs the descrambler 24 to descramble the TS, and output the descrambled one to the de-multiplexing unit 29. The de-multiplexing unit 29 is instructed to execute the multiple separation of the input TS, output of the multiple-separated video ES to the video decoding unit 30, and output of the audio ES to the audio decoding unit 31.

The channel tuning control unit 59 instructs the decoding control unit 57 to decode the video ES and the audio ES respectively input to the video decoding unit 30 and the audio decoding unit 31. Upon reception of the decoding instruction, the decoding control unit 31 controls the video decoding unit 30 to output the decoded video signal to the video conversion processing unit 32, and further controls the audio decoding unit 31 to output the decoded audio signal to the speaker 48 or the audio output unit 42. The control is executed so that the video and audio of the CH designated by the user are output.

The system control unit 51 instructs the OSD creation unit 60 to create and output a CH banner in order to display the CH banner (CH number, program title, OSD for displaying the program information) upon channel tuning. Upon reception of the instruction, the OSD creation unit 60 transmits the resultant CH banner data to the video conversion control unit 61. Upon reception of the data, the video conversion control unit 61 superimposes the CH banner on the video signal for output. In this way, the message upon the channel tuning and the like will be displayed.

<Record of Broadcasting Signal>

The control of recording the broadcasting signal and the signal flow will be described. When recording the specific CH, the system control unit 51 instructs the channel tuning control unit 59 to have channel tuning to the specific CH and output of the signal to the recording/reproducing unit 27.

Likewise the process for receiving broadcasting, upon reception of the instruction, the channel tuning control unit 59 instructs the tuner 23 to control reception of the designated CH, the descrambler 24 to descramble the MPEG2-TS received from the tuner 23, and the de-multiplexing unit 29 to output the input from the descrambler 24 to the recording/reproducing unit 27.

The system control unit 51 instructs the recording/reproducing control unit 58 to record the TS input to the recording/reproducing unit 27. Upon reception of the instruction, the recording/reproducing control unit 58 subjects the signal (TS) input to the recording/reproducing unit 27 to the required process such as encryption, and further writes the MPEG2-TS, additional information and the management data in the recording medium 26 after generating the additional information (program information of recoded CH, contents information such as bit rate) required for recording and reproducing, and recording to the management data (ID of the recorded contents, recorded position on the recording medium 26, recording format, encryption information). In this way, the broadcasting signal is recorded.

<Reproduction from Recording Medium>

The reproducing process from the recording medium will be described. When reproducing the specific program, the system control unit 51 instructs the recording/reproducing control unit 58 to reproduce the specific program, specifically, by instructing the contents ID and the reproduction starting position (for example, head of the program, the position corresponding to elapse of 10 minutes from the head, the point continued from previous reproduction, the position corresponding to 100 MByte from the head).

Upon reception of the instruction, the recording/reproducing control unit 58 controls the recording/reproducing unit 27 to read the signal (TS) from the recording medium 26 using the additional information and the management data so as to output the TS to the de-multiplexing unit 29 after executing the required process such as decoding of cipher.

The system control unit 51 instructs the channel tuning control unit 59 to execute the video audio output of the reproduction signal. Upon reception of the instruction, the channel tuning control unit 59 controls so that the input from the recording/reproducing unit 27 is output to the de-multiplexing unit 29, and instructs the de-multiplexing unit 29 to execute multiple separation of the input TS, output of the multiple-separated vide ES to the video decoding unit 30, and output of the multiple-separated audio ES to the audio decoding unit 31.

The channel tuning control unit 59 instructs the decoding control unit 57 to decode the video ES and the audio ES respectively input to the video decoding unit 30 and the audio decoding unit 31. Upon reception of the decoding instruction, the decoding control unit 31 controls so that the video signal decoded by the video decoding unit 30 is output to the video conversion processing unit 32, and the audio signal decoded by the audio decoding unit 31 is output to the speaker 48 or the audio output unit 42. In this way, the signal reproduction process from the recording medium is executed.

<3D Video Display Method>

For the frame sequential method, the receiver 4 outputs the synchronous signal and the control signal from the control signal output unit 43 and the device control signal transmission terminal 44 to the shutter glasses worn by the user. The video signal from the video signal output unit 41 is output to the external 3DD video display device so as to display the video images for left and right eyes, alternately.

Alternatively, the similar 3D display is performed on the display 47 of the receiver 4. This allows the user who wears the shutter glasses to view the 3D video images on the 3D video display device or the display 47 of the receiver 4.

For the polarization display method, the receiver 4 outputs the video signals from the video signal output unit 41 to the external 3D video display device so that the 3D video display device displays the images for left and right eyes in different polarization states, respectively. Alternatively, the similar display is performed on the display 47 of the receiver 4.

This makes it possible to allow the user who wears the polarizing glasses to view the 3D video images on the 3D video display device or the display 47 of the receiver 4. With the polarization display method, the polarization glasses allow the user to view the 3D video images without transmitting the synchronous signals or the control signals from the receiver 4. SO there is no need of outputting the synchronous signal and the control signal from the control signal output unit 43 and the device control signal transmission terminal 44.

Additionally, the anaglyph method, parallax barrier method, lenticular lens method, microlens array method and integral imaging method may also be employed. The 3D display method according to the present invention is not limited to the specific method.

<Contents Recording Process>

The aforementioned methods may be employed for executing 3D broadcasting of the program with 3D contents. In such a case, it is assumed that the broadcasted 3D contents (hereinafter referred to as “3D broadcasting contents” are converted into the 2D video contents for recording (2D conversion recording) for the purpose of reducing the data size. The embodiment describes the method of appropriately recording the 3D broadcast contents as the 2D contents (contents that contain video signals which may be displayed as the 2D video through the process executed by the display device) in the recording medium of the receiver.

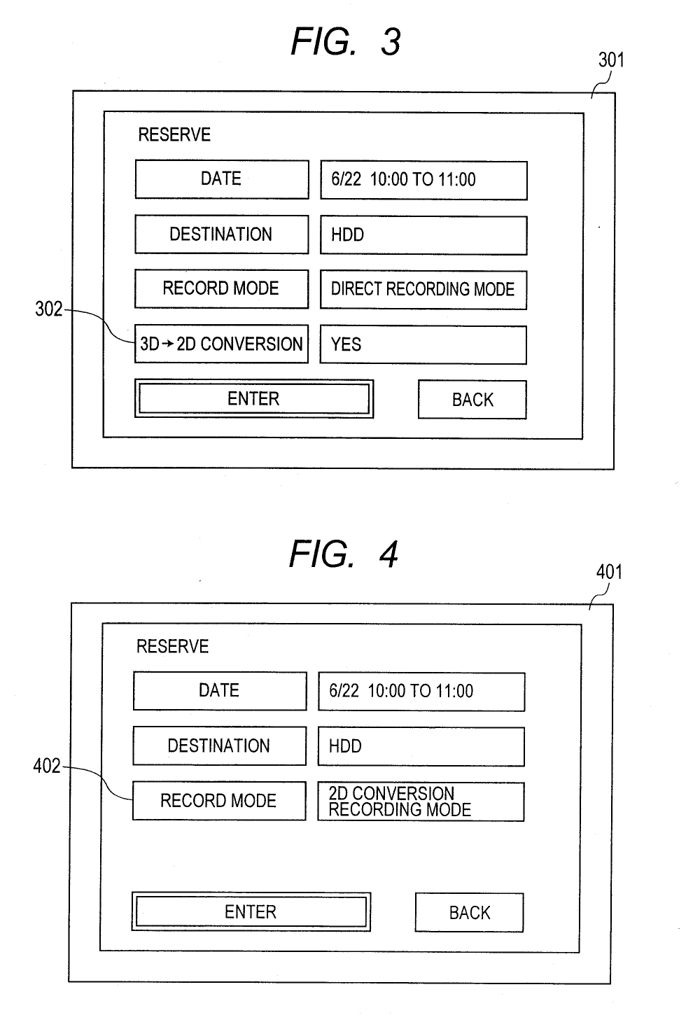

According to the example, the method for selection with respect to execution of the 2D conversion recording will be described. For example, referring to FIGS. 3 and 4, the user is allowed to select to execute or not to execute the conversion in reference to the GUI screen such as the program recording reservation display and dubbing display. This method improves usability as the user is allowed to arbitrarily designate the 2D conversion for each of the respective contents. The system may be configured not to implement the 2D conversion when the program to be reserved is not 3D program requiring no execution of 2D conversion.

With the method having the selection screen such as set menu screen prepared and the set content stored so as to be automatically used upon recording and dubbing thereafter, determination with respect to the need of conversion is not required because of the setting as described above, resulting in improved usability.

With another method, the display performance of the display unit of the receiver or the display unit connected to the receiver is detected so that the receiver automatically selects the 2D conversion recording. For example, for the receiver 4 as shown in FIG. 13, the information indicating the display performance is obtained via the control path from the display 47 (for example, EDID (Extended Display Identification Data) are obtained via HDMI).

It is determined whether the display device is available for displaying the 3D image based on the obtained information. If it is determined that the 3D display is unavailable or the 2D display is only available, the receiver is configured to automatically select the 2D conversion recording upon recording operation. As the 2D conversion recording may be automatically selected, the user does not have to execute the conversion process, thus improving usability.

The process for automatically selecting the 2D conversion recording may be set so that the user is allowed to select available/unavailable in reference to the set menu screen. The method for selection in reference to the set menu allows the user to explicitly determine with respect to execution of the automatic conversion process by the receiver. This makes it possible to improve usability when the automatic conversion process is desired to be made unavailable in the specific state, thus improving usability. The method for determining whether or not the 2D conversion recording is executed according to the example is not limited to those described above.

The respective operations of the elements upon 2D conversion recording of the 3D contents in SBS mode will be described as one example. When the 2D conversion recording is selected, the system control unit 51 is instructed to start the 2D recording. Upon reception of the instruction, the system control unit 51 instructs the recording/reproducing control unit 58 to start 2D conversion recording. Upon reception of the instruction, the recording/reproducing control unit 58 controls the recording/reproduction unit 27 to perform the 2D conversion recording.

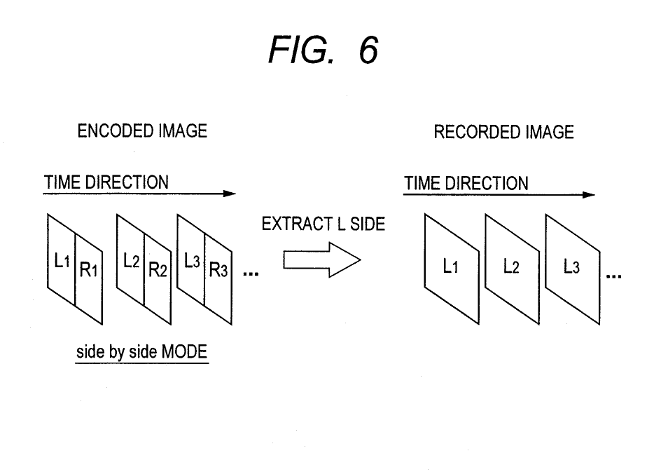

FIG. 6 represents the method for executing 2D conversion recording of video images when executing the 2D conversion recording of the data in SBS mode. An array of frames at left side (L1/R1, L2/R2, L3/R3 . . . ) shown in FIG. 6 represents the video signals in SBS mode where the video signals for left and right eyes are arranged at left and right sides of the single frame.

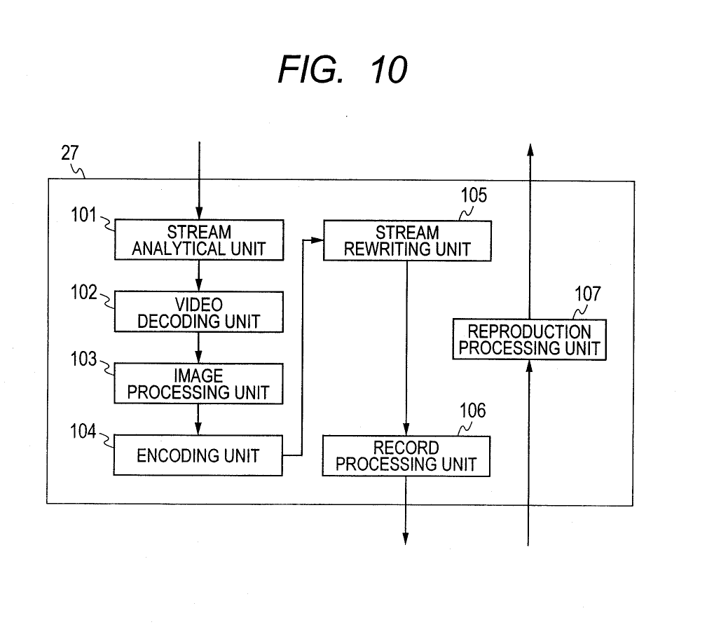

FIG. 10 schematically shows an exemplary functional block diagram including a recording/reproducing unit 27 that executes 2D conversion recording process. A stream analytical unit 101 analyzes the input stream to obtain the internal data such as a 3D identifier, or the data content that is multiplexed into stream such as the program information.

A video decoding unit 102 extracts and decodes the video data from the input stream. For example, the ES that contains the video data are extracted from the stream transmitted with the MPEG2-TS so as to be decoded. The function is different from the video decoding unit of the receiver 4, which is used for mainly executing the image processing. However, the structure employed for decoding the video upon normal operation has no problem when executing the example. An image processing unit 103 executes the process for separating the video data obtained in the video decoding unit into two left and right sections, and enlarging the video data at a predetermined field angle.

An encoding unit 104 executes the process for encoding the video data obtained in the image processing unit 103 to the format which allows the data to be recorded in the recording medium.

A stream rewiring unit 105 rewrites data contained in the stream such as the 3D identifier, and executes re-multiplexing of the video data processed in the aforementioned block and the audio data and other controlling data. For example, if the stream format for recording is MPEG2-TS, re-multiplexing is executed for achieving such format. The data rewritten in the example such as 3D identifier will be described later. A record processing unit 106 executes the process for accessing the recording medium to be connected and writing data.

A reproduction processing unit 107 executes reproduction from the recording medium. Those functional blocks may be installed as hardware or as the module formed of software. The recording/reproducing unit 27 is controlled by the recording/reproducing control unit 58 as the functional module in the CPU 21. The respective functional modules in the recording/reproducing unit 27 may be automatically or individually operated. The order for connecting those functional blocks as shown in the drawing is a mere example. No problem occurs even if the order is changed. When the 2D conversion recording is not executed, no process is executed while passing all the functions of the stream analytical unit 101, the video decoding unit 102, the image processing unit 103, the encoding unit 104, and the stream rewriting unit 105 so that the stream is input to the record processing unit 106 for recording. Alternatively, the input stream may be directly input to the record processing unit 106 without passing all those functional blocks.

The recording/reproducing unit 27 may be configured to have the functional blocks for executing decoding of cipher, changing compression format (transcode and re-encode), executing compression recording (translate) by lowering the bit rate of the recorded data, and realizing high definition using the super-resolution technique.

The transcode used in this example denotes the technique and process for changing video compression format and compression rate by encoding the compressed and/or encoded video data again without decoding, or the partially decoded data.

The term re-encoding described in this example denotes the technique and process for changing the video compression format and the compression rate by decoding the compressed and/or encoded video data, and re-encoding the decoded data.

The term translate described in this example denotes the technique and process for changing the bit rate (mainly compressing) of the compressed and/or encoded video data without changing the encoding mode and compression format. Explanation and drawing with respect to those functional blocks will be omitted for simplification.

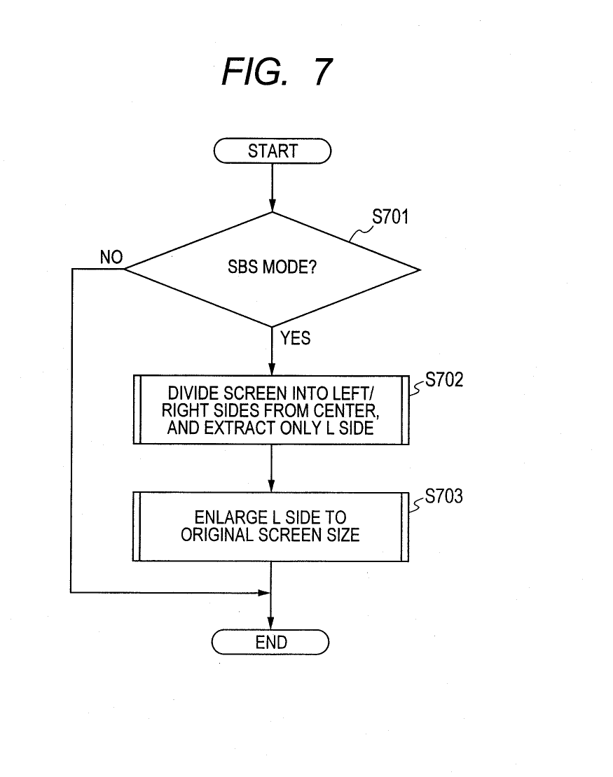

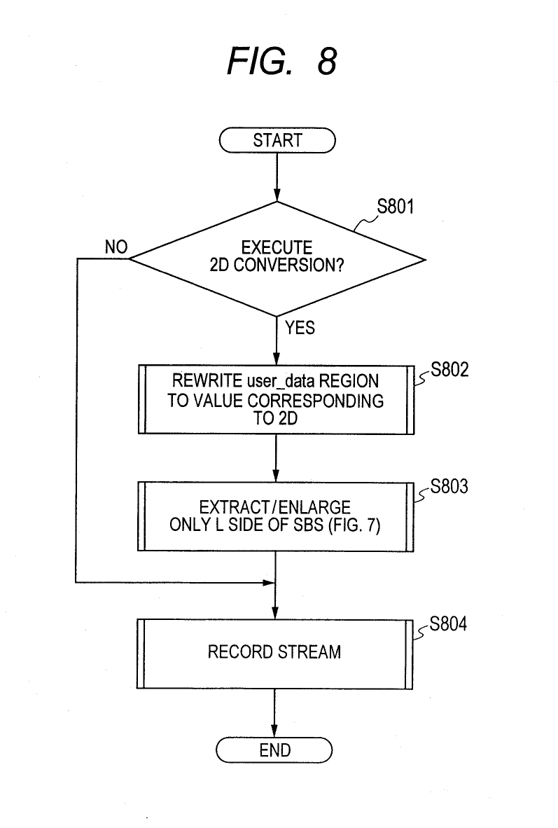

FIG. 7 represents the process for executing 2D conversion of the contents in SBS mode. After starting the process, it is determined whether the data mode is SBS. The determination is made by analyzing the stream by the stream analytical unit 101 in reference to existence of the 3D identifier indicating the 3D video mode, and the content thereof.

If it is determined that the data mode is not SBS, the process ends. The determination may be made with respect to the data mode other than the SBS mode sequentially so as to proceed to 2D conversion process in the corresponding mode. This makes it possible to determine with respect to a plurality of modes in the single process, and to proceed to the 2D conversion process, thus simplifying the user operation and improving usability.

If it is determined that the data mode is SBS, the process proceeds to S702 where each frame of the video signal in SBS mode decoded by the video decoding unit 102 is subjected to separation of the video data into left and right sections from the center of the screen by the image processing unit 103. Then the frames of the left-eye image (L side) and the right-eye image (R side) are obtained.

The program then proceeds to S703 where the image processing unit 103 executes scaling (enlarging) of the main view-point video image (for example, L side) only so that the main view-point video image (left-eye video image) is only extracted as the video signal as shown by the array of frames at right side (L1, L2, L3 . . . ), the encoding unit 104 executes encoding and outputs the video data. The process then ends. As described above, the converted 2D video stream is obtained. The process records the stream as the 2D contents in the recording medium 26. It is to be understood that the present invention is not limited to the 3D video format and the 2D conversion recording method as described above.

Additionally, the data indicating the 3D contents in the user data region are rewritten upon execution of the 2D conversion recording using the aforementioned method so as to change data to those indicating the 2D contents.

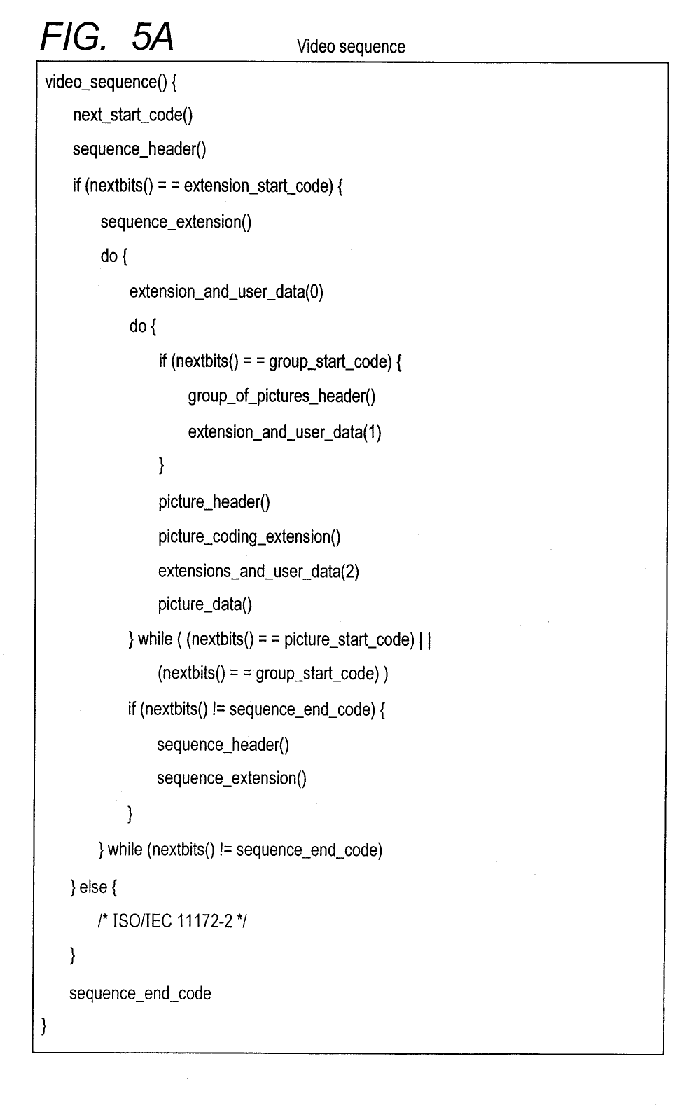

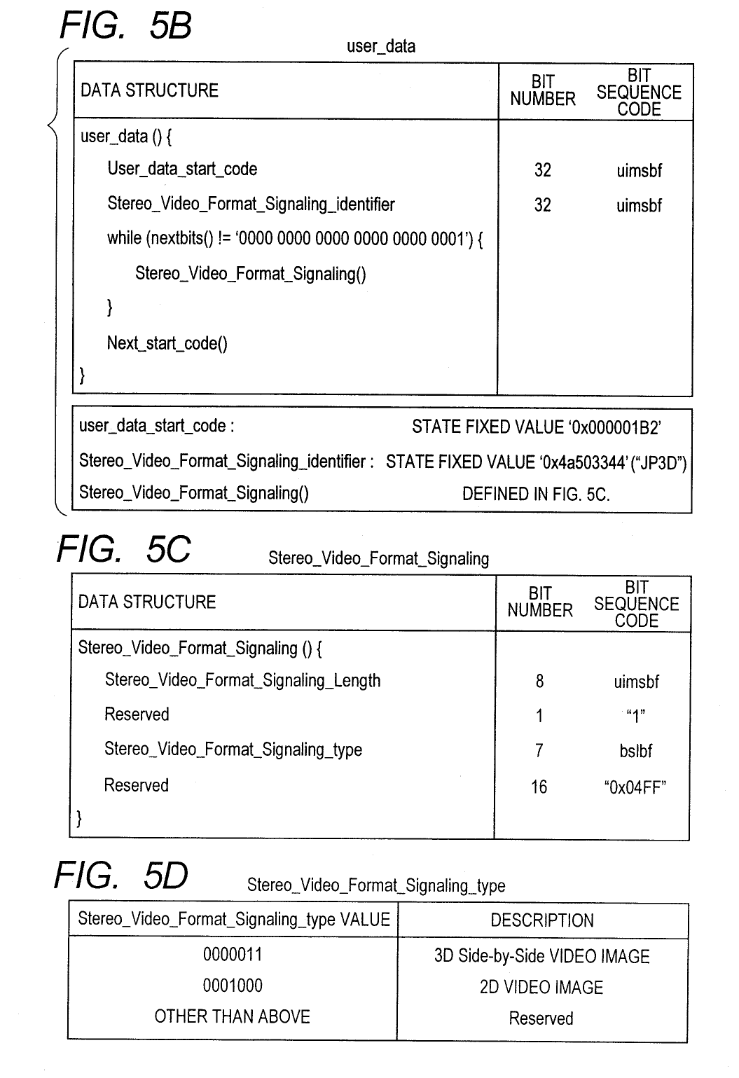

An exemplary data structure which contains 3D identifier for rewiring is shown in FIGS. 5A, 5B, 5C and 5D. This example defines 3D identifier in user_data of the MPEG-2 video picture layer.

Referring to FIG. 5A, user_data is applied to the picture layer in video_sequence.

Stereo_Video_Format_Signaling is defined in user_data in accordance with FIG. 5B. In this example, only one of Stereo_Video_Format_Signaling ( ) is assigned in user_data ( ).

The data Stereo_Video_Format_Signaling_type in Stereo_Video_Format_Signaline shown by FIG. 5C identify 3D video format, and indicates the type of each format in accordance with FIG. 5D.

For this example, the value becomes 0000011 in the SBS mode, and 0001000 in 2D mode. In the example, the description Video_Format_Signaling_type corresponds to the 3D identifier. The 3D video format is explained with respect only to SBS mode for simplification. However, definition and the relevant stream type of the 3D identifier are not limited to the SBS mode. The TAB mode, 3D 2-viewpoint classified ES transmission mode (multi-viewpoint stream) may be individually defined and employed.

FIG. 8 shows an exemplary 2D conversion recording process according to the example. After starting the process, it is determined whether the conversion recording into 2D contents is executed in S801. The determination may be made by detecting the display performance of the receiver or the display performance of the connected display device for automatic selection, or presenting the GUI screen as shown in FIGS. 3 and 4 so as to allow the user to select. Any other method may be employed.

When 2D conversion is not executed, the process proceeds to S804 where the stream is recorded as 3D contents. The process then ends. When 2D conversion is executed, the process proceeds to S802 where the 3D identifier of the stream is rewritten from the value indicating SBS mode into the value indicating 2D video image in the stream rewiring unit 105.

As for the data structure as described above, the value of Stereo_Video_Format_Signaling_type which exists in user_data of the picture layer in the stream is rewritten from 0000011 to 0001000.

Thereafter, the process proceeds to S803 where the process for executing 2D conversion of the stream in SBS mode in accordance with the 2D conversion method as described above. In S803, the L-side video image in SBS mode as described referring to FIG. 7 is extracted and enlarged to obtain the 2D image.

After rewriting the 3D identifier and extracting the stream of 2D video format, the process proceeds to S804 where the stream is recorded in the recording medium. The process then ends. Upon recording in S804, the compression format may be changed in the recording processing unit 106 (transcode and re-encode), the bit rate of the recording data is lowered to execute compression recording (translate), and realizing high definition through super-resolution technique. The aforementioned process is added to provide advantage which allows implementation in accordance with user's needs.

In the case where the compression mode of the contents derived from subjecting the 3D contents in SBS mode to 2D conversion is changed from the MPEG2 to MPEG4-AVC upon recording, the process is executed for restructuring the stream without adding Frame_packing_arrangement_SEI in accordance with the value of the identifier rewritten in S802, or rewriting so as to be added as the appropriate value (setting the value of frame_packing_arranngement_flag to 1 defined as 2D), thus providing the similar effect.

Steps S802 and S803 are applied to different points as results of the respective processes in the stream, and they may provide similar effects by executing those steps in reverse order. When executing conversion from 3D video image into the 2D video image, the 3D identifier may be deleted. As the data structure has compatibility with the generally employed 2D broadcasting type irrespective of no 3D identifier. So the receiver is capable of recognizing the 2D video image although 3D identifier is deleted.

For the above-described example, user_data is used for the picture layer in video_sequence defined by the MPEG2 video. However, the present invention is not limited to the one as described above. For example, the program information (for example, SI, component descriptor) may be used for the method which allows rewriting or deletion of the 3D identifier defined in those data. In such a case, the stream analytical unit 101 of the recording/reproducing unit 27 analyzes the program information derived from the de-multiplexing unit 29 so that the data indicating the 3D identifier is rewritten or deleted from the program information. The 3D identifier by itself may be deleted. This method allows execution of the same process using the program information without user_data of the picture layer in video_sequence.

The 3D identifier contained in the program information, for example, SI may be used simultaneously with the 3D identifier contained in user_data of the picture layer in video_sequence defined by the MPEG2 video. In such a case, the information indicating whether the 3D video is contained or not is only added to the SI so as to add the information which identifies the 3D method used for the 3D video image to user_data.

In the exemplary process as described above, SI with the information indicating existence of 3D video image is deleted upon 2D conversion recording, and the information content indicating 3D mode contained in user_data is rewritten or deleted. The 3D identifier may be directly deleted. The rewriting or deleting process may employ the respective methods as described above, or any other method. Such method allows use of both the 3D identifier contained in SI and the one of user_data for more flexible processing.

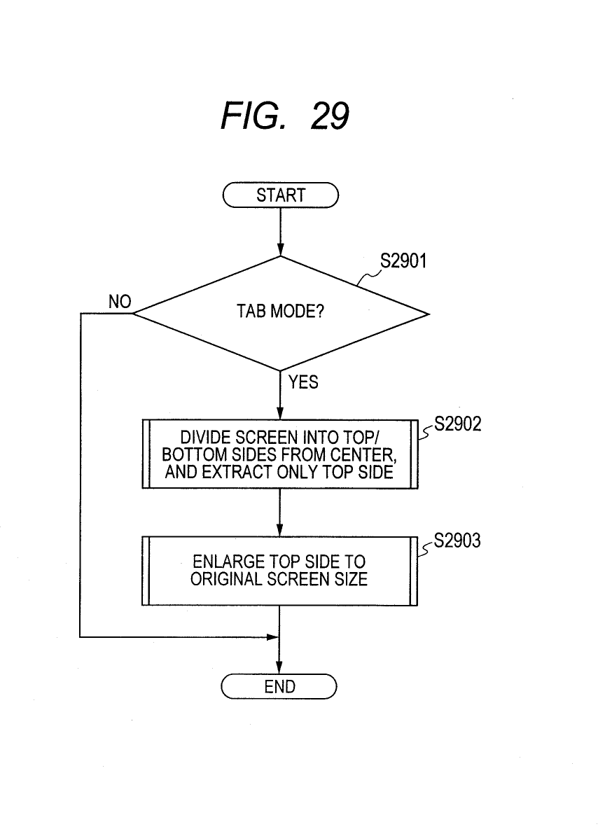

In the aforementioned example, the 3D transmission in SBS mode has been described. However, the other mode such as TAB mode and 2-viewpoint classified ES transmission mode may be employed. FIG. 29 represents an example of the process for 2D conversion of TAB mode. After starting the process, it is determined with respect to the TAB mode in S2901. The determination may be made by analyzing the stream in the stream analytical unit 101 in reference to existence of the 3D identifier indicating 3D video mode and its content.

If it is determined that the TAB mode is not used, the process ends. If it is determined that the TAB mode is used, the process proceeds to S2902 where each frame of the video signal in TAB mode, decoded in the video decoding unit 102 is separated into the one for left-eye video image (top side) and right-eye video image (bottom side) corresponding to the top and bottom sections of the image from the center of the screen, which is executed by the image processing unit 103. Then the process proceeds to S2903 where the main viewpoint video image (for example, top side) is only enlarged by the image processing unit 103, and the main viewpoint video (left-eye video image) is only extracted and output as the video signal. The process then ends. The data of 2D display format may be obtained through the aforementioned process.

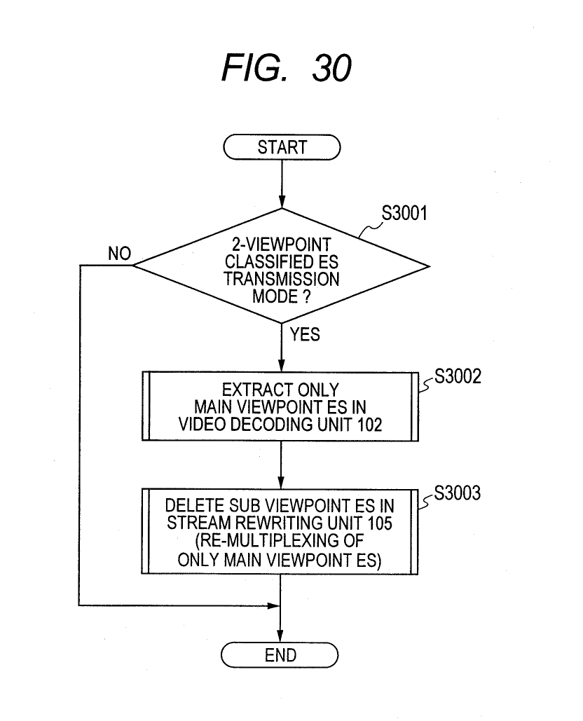

FIG. 30 represents the process for executing 2D conversion in 2-viewpoint classified ES transmission mode. After starting the process, it is determined with respect to the 2-viewpoint classified ES transmission mode. The determination is made by analyzing the stream by the stream analytical unit 101 in reference to existence and content of the 3D identifier indicating the 3D video mode.

If it is determined that the 2-viewpoint classified ES transmission mode is not used, the process ends. If the 2-viewpoint classified ES transmission mode is used, the process proceeds to S3002, and only data set as the main view point ES are extracted from the video signals decoded by the video decoding unit 102. The process then proceeds to S3003 where the main viewpoint ES extracted in S3002 is only used as the video signal upon re-multiplexing executed by the stream rewiring unit 105. In other words, the main viewpoint video image is output by deleting the sub viewpoint ES which is not extracted in S3002. The process then ends. The above described process provides data in the 2D display format. In this way, the 2D conversion recording is executed with the method adapted for each 3D transmission mode.

This example allows the 3D contents to be recorded as 2D contents in accordance with the data format that can be handled by the receiver, and the recorded 2D contents to be appropriately handled.

When data size of the 3D contents is smaller than that of the 2D contents (for example, upon conversion of 3D contents in 2-viewpoint classified ES transmission mode into 2D contents, the data size is reduced resulting from deletion of the sub-viewpoint ES.), thus providing advantage of reducing the data storage capacity compared to the case where the 3D contents are directly stored. When outputting the data to the display device capable of changing the display mode in accordance with the 3D identifier, and the converted contents are managed by the recording device, for example, advantage of ensuring appropriate display, and accurate determination with respect to the 2D contents.

When the recording medium 26 is a removable device (for example, removable HDD), there may the case where the recording medium 26 is removed and connected to the other recording/reproducing device (or receiver, display device) for reproduction. In such a case, although the connected recording/reproducing device is available only for the 2D contents, the method according to the example allows conversion into 2D contents and further prevention of disaccord of the 3D identifier. This makes it possible to improve compatibility with the other device.

An example of the process for converting the 2D broadcasting contents of the generally employed mode into the 3D contents to be output will be described.

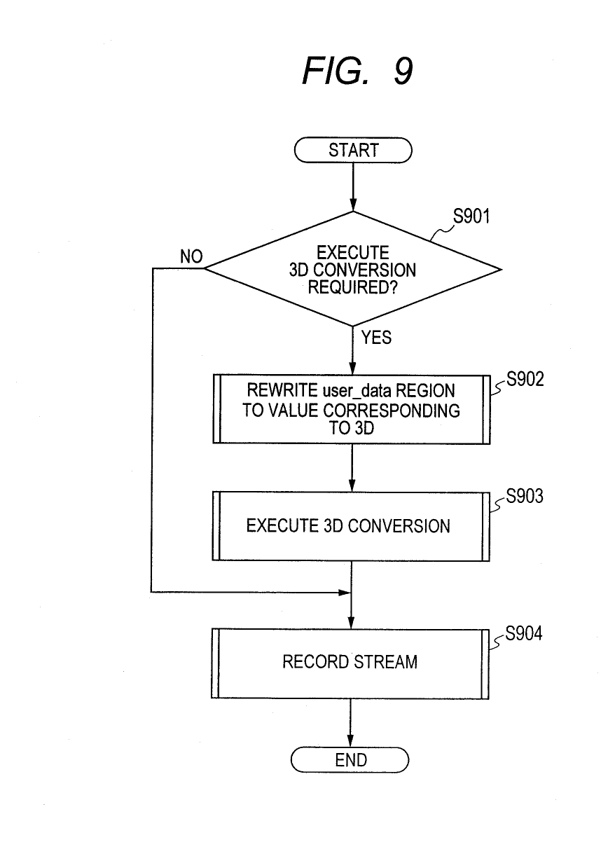

FIG. 9 represents an exemplary process for 3D conversion recording according to the example. It is assumed that the data structure indicating the 3D identifier is similar to the one as shown in FIGS. 5A to 5D, and the arbitrary 3D video format may be used. However, the present invention is not limited to the one as described above.

After starting the process, it is determined whether conversion to the 3D contents is executed in S901. If it is determined that the 3D conversion is not executed, the process proceeds to S904 where the stream is recorded as 2D contents, and the program ends.

If the 3D conversion is executed, the process proceeds to S902 where the 3D identifier of the stream is rewritten from the value indicating 2D to the one indicating 3D video by the recording/reproducing unit 27. Alternatively, the 3D identifier is added. The value according to the format by which the conversion executed in the subsequent step S903 may be used.

When executing conversion into the 3D contents in SBS mode, the value of Stereo_Video_Format_Signaling_type in user_data of the picture layer that exists in the stream as shown in FIG. 5D is rewritten from 0001000 to 0000011. Then the process proceeds to S903 where the 3D conversion process is executed. The specific process for 3D conversion will be described later.

After rewriting the 3D identifier, and generating the stream of 3D video format, the process proceeds to S904 where the resultant stream is recorded in the recording medium. The process then ends.

Upon recording in S904, it is possible to execute such process as changing compression format (transcode and re-encode), compression recording (translate) by lowering the bit rate of recording data, and realizing high-definition using super-resolution technique. The aforementioned process provides advantages to additionally execute the aforementioned process, thus ensuring implementation adapted for user's needs.

When changing the compression format of the contents obtained by subjecting 2D contents to 3D conversion in SBS mode from MPEG2 to MPEG4-AVC upon recording, Frame_packing_arrangement_SEI is added in accordance with the value of the identifier rewritten in S902, and the appropriate value is set. For example, the value of frame_packing_arrangement_type is set to 3 indicating SBS mode after setting the value of frame_packing_arrangement_flag to 0 define as 3D, thus providing the similar effect. Steps S902 and S903 are applied to the different processes in the stream, which may provide similar effects in spite of reversed order of execution.

The method for adding parallax based on estimated depth in the analyzed image may be considered as the 3D conversion method. The image to which parallax is added is converted into the format such as the SBS mode so as to obtain 3D images. However, the 3D conversion process according to the example is not limited to the one as described above. The display format after 3D conversion includes SBS mode, 3D 2-viewpoint classified ES transmission mode, and TAB mode without being limited thereto.

For the above-described example, user_data is used for the picture layer in video_sequence defined by the MPEG2 video. However, the present invention is not limited to the one as described above. For example, the program information (for example, SI, component descriptor) may be used for the method which allows adding or rewriting of the 3D identifier defined in those data. In such a case, the stream analytical unit 101 of the recording/reproducing unit 27 analyzes the program information derived from the de-multiplexing unit 29 so that the data indicating the 3D identifier is added or rewritten to the program information. The 3D identifier by itself may be deleted. This method allows execution of the same process using the program information without user_data of the picture layer in video_sequence.

The 3D identifier contained in the program information, for example, SI may be used simultaneously with the 3D identifier contained in user_data of the picture layer in video_sequence defined by the MPEG2 video. In such a case, the information indicating existence of the 3D video is added to the SI upon 3D conversion recording, and the information and identifier indicating 3D mode may be added or rewritten to user_data. The aforementioned method or any other method may be employed as the one for adding and rewiring, respectively. Such method allows the use of both 3D identifier contained in SI and the 3D identifier of user_data for more flexible processing.

The example allows the 2D contents in generally employed broadcasting mode to be recorded as 3D contents which provides higher realistic sensation, and further ensures appropriate handling of the recorded 3D contents. Specifically, the display device capable of changing the display method in accordance with the 3D identifier is allowed to provide appropriate display. When managing the converted contents by the recording device, accurate determination as to 3D contents may be made.

The process for recording the 3D contents with no identifier (with identifier of the value indicating 2D contents exist) will be described hereinafter.

There may be the broadcasting of the 3D contents with no 3D identified or the contents with 3D identifier having the value indicating 2D contents because of no need of inserting the 3D identifier according to standard, or the timing for transferring to the 3D contents broadcasting and facilities of the broadcasting station.

In the case where the aforementioned contents are recorded as they are in the receiver capable of displaying 3D image, identification with 3D identifier cannot be performed. This may mislead the determination as having 2D contents upon reproduction, thus failing to perform 3D display. With the aforementioned process, the user who wants to have 3D display when reproducing the contents is required to select to the 3D display every time. This may deteriorate usability.

The example allows the receiver to add and record the 3D identifier when recording the 3D contents with no 3D identifier (with identifier having the value indicating 2D contents).

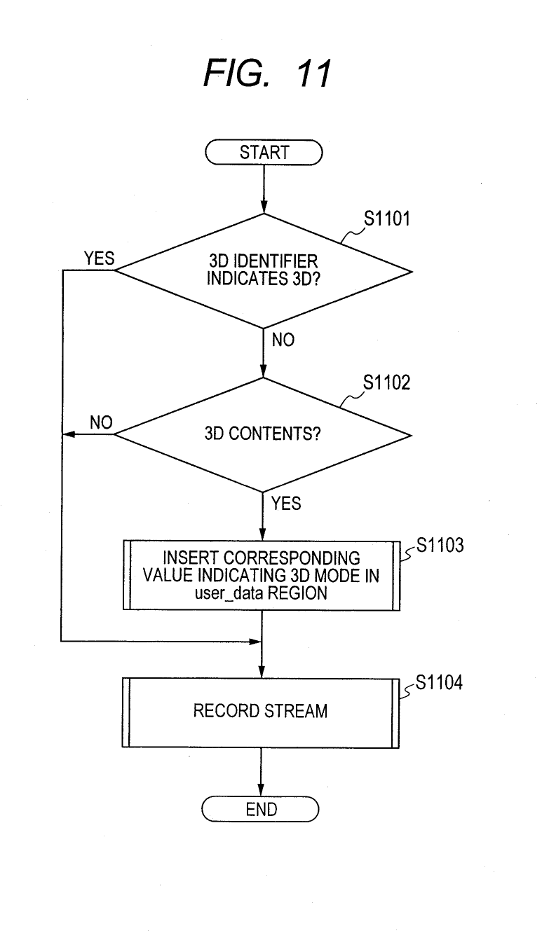

FIG. 11 represents an exemplary process executed in the present example. It is assumed that the data structure indicating the 3D identifier is similar to those shown in FIGS. 5A to 5D, which is not limited thereto.

After starting the process, the determination with respect to the 3D identifier value is made in S1101. The process is executed by checking whether the value of the 3D identifier indicates the 3D contents based on the analysis of the stream, which is executed by the stream analytical unit 101 in the recording/reproducing unit 27.

If it is determined that the 3D identifier is the value indicating 3D contents in S1101, the process proceeds to S1104 where the stream is recorded as 3D contents. If the 3D identifier is not the value indicating the 3D contents, the process proceeds to S1102 where it is determined whether or not the stream is in 3 contents format. The algorithm used for the determination will be described later.

If it is determined that the identifier is the value indicating 2D contents, the process proceeds to S1104 where the stream is recorded as 2D contents. If it is determined that the identifier is the value indicating 3D contents, the process proceeds to 1103 where the 3D identifier is inserted.

With the method, the recording/reproducing unit 27 detects the position that allows insertion of the 3D identifier in the stream, the data having the value indicating the 3D video are inserted (rewritten) into the detected position. The value of the 3D identifier is set in accordance with the mode of the 3D contents as a result of determination. For example, if the mode of the 3D contents is determined as SBS mode, data with the value 0000011 as Stereo_Video_Format_Signaling_type as shown in FIG. 5D are inserted into user_data of the picture layer that exists in the stream.

After rewriting the 3D identifier in S1103, the process proceeds to S1104 where the stream is recorded. The process, then ends. Upon recording in S1104, it is possible to execute such process as changing compression format (transcode and re-encode), compression recording (translate) by lowering the bit rate of recording data, and realizing high-definition using super-resolution technique. It is advantageous to additionally execute the aforementioned process, thus ensuring implementation adapted for user's needs.

When changing the compression format of the contents obtained by rewiring the 3D identifier from MPEG2 to MPEG4-AVC upon recording, Frame_packing_arrangement_SEI is added in accordance with the value of the identifier rewritten in S1103, and the appropriate value is set. For example, the value of frame_packing_arrangement_type is set to 3 indicating SBS mode after setting the value of frame_packing_arrangement_flag to 0 define as 3D, thus providing the similar effect.

In the example, the determination with respect to 3D contents to be recorded cannot be made using the 3D contents (because of 3D contents without 3D identifier). So the method which notifies the receiver of 3D contents by determination and operation of the user upon recording may be employed. The method allows the user to determine with respect to existence of added 3D identifier for each of the contents, thus improving usability.

For the 3D contents in SBS mode, left-eye and right eye images are arranged at left and right sides. The image processing unit 103 separates the image at a certain time into left and right sides from the center, and brightness histograms are created for the respective sides which will be compared. If the comparison result shows that left and right images have similarity, it is determined that the mode of the 3D contents is SBS. Another method allows the receiver to automatically determine with respect to 3D contents using the aforementioned algorithm. The method capable of automatically determining with respect to 3D contents to add 3D identifier does not require the user to determine and operate with respect to addition of the 3D identifier, thus improving usability.

The 3D contents determination method according to the present invention is not limited to those described above. The determination may be made by the software controlled by the CPU 21. Alternatively, hardware and/or software serving as the determination unit may be additionally provided for making such determination.

The example has been described taking user_data of the picture layer in video_sequence defined by the MPEG2 video as the example. However, the present invention is not limited to the one as described above. For example, the method using the program information (SI, component descriptor) may be employed so that the 3D identifier defined in those data is added or rewritten. In such a case, the data indicating the 3D identifier are added to the SI or rewritten in accordance with the 3D mode of the contents by the stream rewiring unit 105 of the recording/reproducing unit 27. The method allows execution of the similar processing using the program information in the absence of user_data of the picture layer in video_sequence.

The 3D identifier contained in the program information, for example, SI may be used simultaneously with the 3D identifier contained in user_data of the picture layer in video_sequence defined by the MPEG2 video. In such a case, the information indicating existence of the 3D video is added to the SI, and the information and identifier indicating 3D mode may be rewritten or added to user_data. The aforementioned method or any other method may be employed as the one for adding and rewiring, respectively. Such method allows the use of both 3D identifier contained in SI and the 3D identifier of user_data for more flexible processing.

According to the example, the added 3D identifier is recorded so that the recorded contents may be handled by the receiver as 3D contents in spite of the stream having 3D contents without 3D identifier. This makes it possible to improve usability.

The method for determining addition of the 3D identifier to the stream having 3D contents with no 3D identifier may be designed so that the user is allowed to have such selection from the set menu screen or recording reservation screen. The method for selecting the setting from the screen such as the set menu allows the user to explicitly determine with respect to adding 3D identifier, resulting in improved usability.

There may be the broadcasting of 2D contents to which 3D identifier indicating the 3D contents is added because of broadcasting failure or error. If the contents are recorded in the receiver as they are, the receiver capable of executing the 3D display is misled to identify the 2D contents as 3D contents in the course of determining the type of contents, and displays such contents in the 3D display mode, thus failing to provide appropriate display. The aforementioned receiver requires the user to select the 2D display mode every time when reproducing the contents, resulting in deteriorated usability.

The example allows the receiver to delete the 3D contents identifier upon recording when the 3D identifier is added to the 2D contents to be recorded.

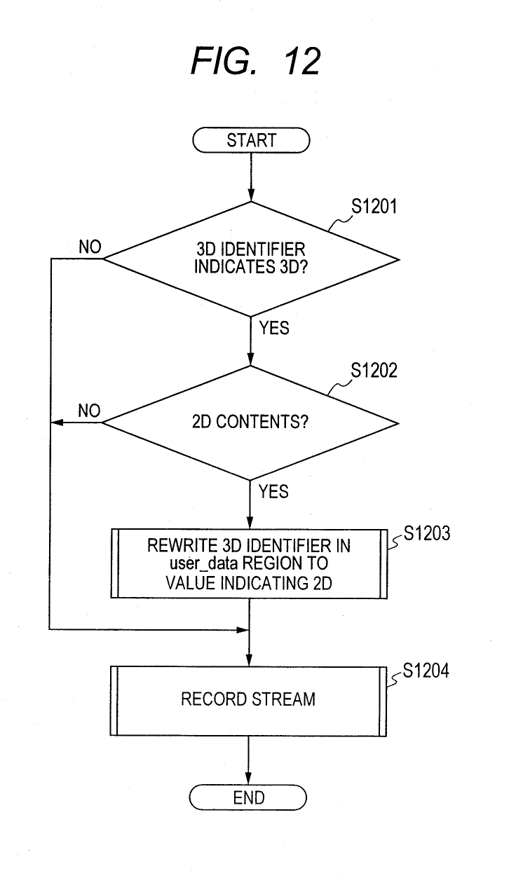

FIG. 12 represents an exemplary process executed in the present example. It is assumed that the data structure indicating the 3D identifier is similar to those shown in FIGS. 5A to 5D, which is not limited thereto.

After starting the process, the determination with respect to the 3D identifier value is made in S1201. The process is executed by checking whether the value of the 3D identifier indicates the 3D contents based on the analysis of the stream, which is executed by the stream analytical unit 101 in the recording/reproducing unit 27. When it is determined in S1201 that the 3D identifier is the value indicating 2D contents, the process proceeds to S1204 where the stream is recorded as the 2D contents.

If the 3D identifier is the value indicating 3D contents, the process proceeds to S1202 where it is determined whether the stream has 2D contents. The determination algorithm may be in accordance with the method for determining with respect to 3D contents as describe above or any other method.

If it is determined in S1202 that the identifier is the value indicating 3D contents, the process proceeds to S1204 where the stream is recorded as 3D contents. If it is determined that the identifier is the value indicating 2D contents, the process proceeds to 1203 where the 3D identifier value indicating 3D contents is rewritten (or 3D identifier is delete).

With the method, the recording/reproducing unit 27 detects the 3D identifier in the stream, the value of which is rewritten to the one indicating 2D video. Specifically, the value of Stereo_Video_Format_Signaling_type as shown in FIG. 5D in user_data of the picture layer that exists in the stream is rewritten to 0001000. After rewiring the 3D identifier in S1203, the process proceeds to S1204 where the stream is recorded. The process then ends.

It is possible to execute such process as changing compression format (transcode and re-encode), compression recording (translate) by lowering the bit rate of recording data, and realizing high-definition using super-resolution technique. It is advantageous to additionally execute the aforementioned process, thus ensuring implementation adapted for user's needs. When changing the compression format of the contents obtained by subjecting 3D contents to 2D conversion in SBS mode from MPEG2 to MPEG4-AVC upon recording, the stream is restructured without adding Frame_packing_arrangement_SEI in accordance with the value of the identifier rewritten in S1203. Alternatively, it may be added as the appropriate value by executing the rewriting process (value of frame_packing_arrangement_flag is set to 1 defined as 2D) to provide the similar effect.

The example has been described taking user_data of the picture layer in video_sequence defined by the MPEG2 video as the example. However, the present invention is not limited to the one as described above. For example, the method using the program information (SI, component descriptor) may be employed so that the 3D identifier defined in those data is rewritten or deleted. In such a case, the data indicating the 3D identifier are rewritten or deleted by the stream rewriting unit 105 in accordance with the program information derived from the de-multiplexing unit 29, which is analyzed by the stream analytical unit 101 of the recording/reproducing unit 27. The 3D identifier may be directly deleted. The method allows the similar process using the program information although there is no user_data of the picture layer in video_sequence.

If the 3D identifier contained in the program information, for example, SI and the 3D identifier contained in user_data of the picture layer in video_sequence defined by the MPEG2 video are contained, the SI with the information indicating existence of the 3D video is deleted. Furthermore, the information indicating 3D mode contained in user_data is rewritten or deleted. The 3D identifier may be directly deleted. The aforementioned method or any other method may be employed as the one for rewiring and deleting, respectively. Such method allows the use of both 3D identifier contained in SI and the 3D identifier of user_data for more flexible processing.

According to the example, although the 3D identifier has been added to the stream of 2D contents because of error, the receiver is capable of accurately handling the added data as 2D contents by deleting (rewriting) the 3D identifier, thus further improving usability upon viewing.

The method for determining deletion (rewriting) of the 3D identifier of the stream with 2D contents to which the 3D identifier has been added may be designed so that the user is allowed to have such selection from the set menu screen or recording reservation screen.

The processes described in this example may be used not only for directly recording the received broadcast in the recording medium but also for changing the compression format of the contents once recorded in the recording medium (transcode and re-encode), and executing compression recording (translate) by lowering the bit rate of the recording data, and writing the data that have been subjected to high-definition processing through super-resolution technique in the recording medium again.

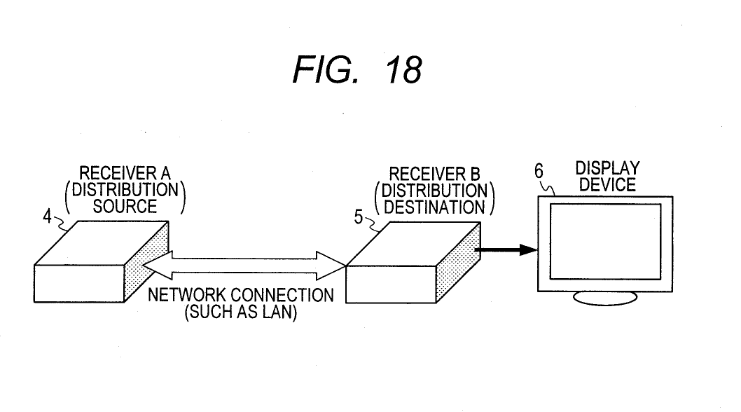

Distribution of the 3D contents recorded in the receiver to the other device via network such as LAN (Local Area Network) will be described. FIG. 18 represents an exemplary configuration of the receiver and the other device which are connected via network. For example, likewise the receiver 4 as described above, a receiver A (distribution source) 4 is a device capable of receiving and recording the broadcasting with 3D contents. A receiver B (distribution destination) 5 is the device capable of receiving the stream data transmitted via the network.

The receiver B (distribution destination) 5 may be configured to have the same functions as those of the receiver 4 as described above. Functions of decoding the stream data received inside, and recording the data in the built-in recording medium may further be provided.

A display device 6 is configured to display the data that can be displayed on the display unit, which has been obtained by decoding the data received by the receiver B (distribution destination) 5. The receiver B (destination destination) 5 may be combined with the display device 6. The receiver A (distribution source) 4 may be connected to the display device. Alternatively, the receiver A (distribution source) 4 may be provided with the display unit.

Data may be distributed via network using DLNA (Digital Living Network Alliance), for example. The contents requiring copyright protection are subjected to encryption through DTCP-IP (Digital Transmission Content Protection over Internet Protocol) so as to be distributed.

The device as the distribution destination is capable of displaying the received contents or recording the contents in the recording medium. The example validates the distribution method while changing the display format of the 3D or 2D contents. The display format may be determined based on the user's operation of the receiver as the distribution source. Alternatively, the mechanism that allows the user to acquire display performance information of the distribution destination so that the format is automatically determined based on the display performance information.

As an example of the latter case, the method for distributing the data that have been automatically converted into 2D contents may be considered when it is determined that the distribution destination is only available for 2D display based on the display performance information. The method for selecting the display format will be described later. The distribution of data derived from converting the display format of 3D contents to the 2D display format will be referred to as 2D conversion distribution in the subsequent description.

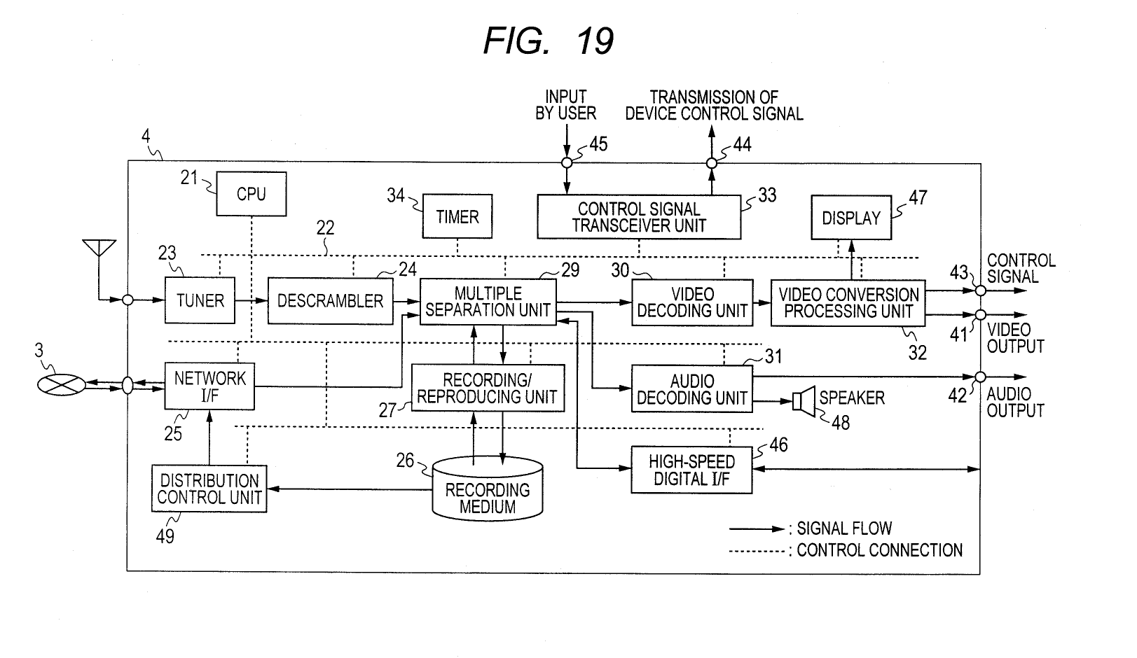

FIG. 19 shows an exemplary structure of the device as the distribution source. A distribution control unit 49 converts the display format of the data read from the recording medium 26 to the one which allows the data to be distributed, and sends the converted data to the network I/F 25. Other functional blocks are the same as those described referring to FIG. 13. A high-speed digital I/F may be employed instead of the network I/F for distribution.

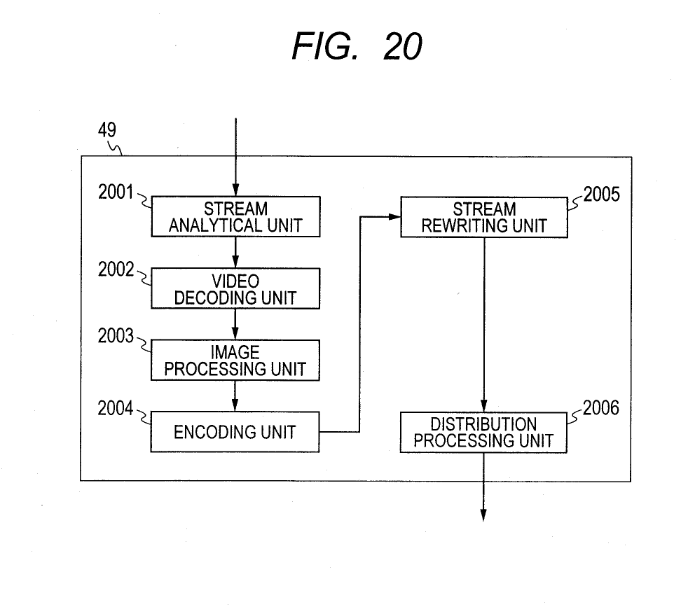

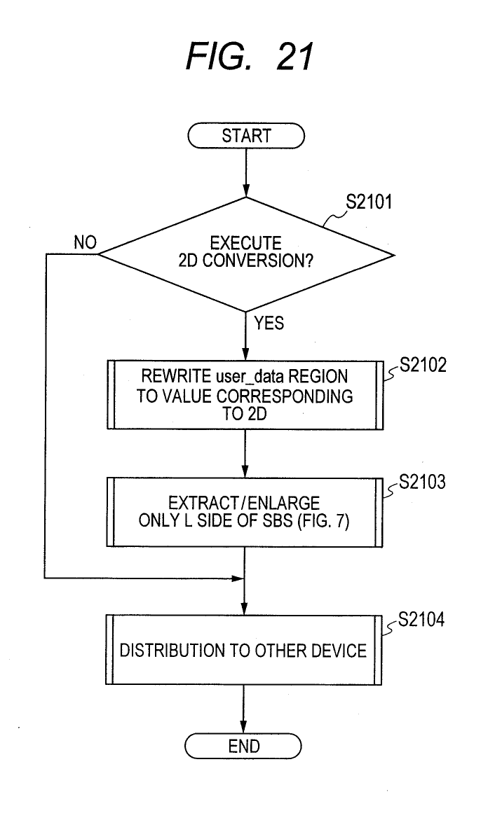

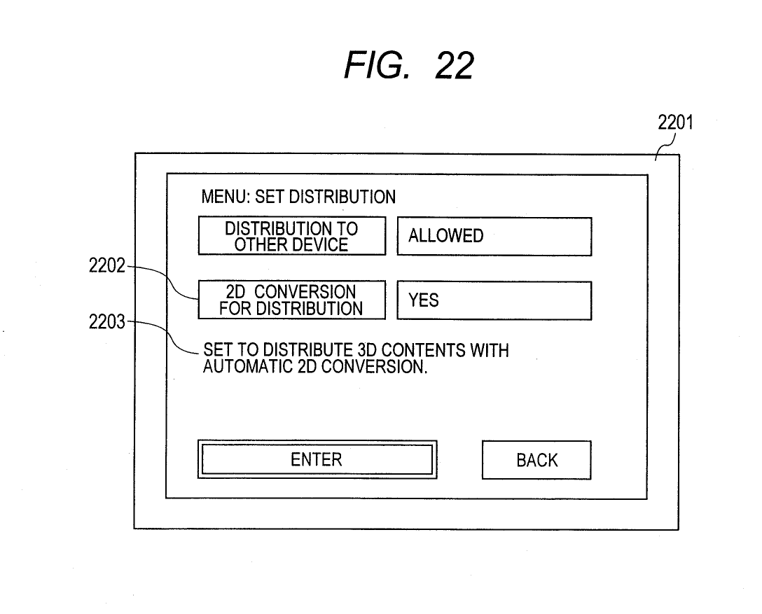

FIG. 20 schematically shows exemplary functional blocks inside the distribution control unit 49 for converting the 3D contents into the 2D contents. A stream analytical unit 2001 analyzes the input stream obtained from the recording medium 26 to obtain the internal data such as the 3D identifier. The content of the data multiplexed to the stream such as the program information may be obtained.

An image decoding unit 2002 decodes the video data of the input stream. The decoding unit is mainly used for executing image processing, and has the different function from that of the video decoding unit of the receiver A (distribution source) 4. However, it may be used for video decoding in a normal operation. An image processing unit 2003 executes image processing, for example, separating the video data derived from the video decoding unit 2002 into two left and right sections, and enlarging the video data at a predetermined field angle.

An encoding unit 2004 executes the process, for example, encoding the video data derived from the image processing unit 2003 into the one with the format which allows recording in the recording medium.

A stream rewriting unit 2005 executes rewiring of data contained in the stream, for example, 3D identifier, and re-multiplexing of the video data processed in the aforementioned block, audio data and other controlling data. For example, if the format of the stream to be distributed is MPEG2-TS, re-multiplexing is executed to realize such format. The data to be rewritten in the example may be presented as the 3D identifier (FIGS. 5A to 5D). A distribution processing unit 2006 executes packetization for network transmission and encryption in need.

The order for connecting those functional blocks as shown in the drawing is a mere example, and it is possible to change the order appropriately. When the 2D conversion distribution is not executed, no process is executed while passing all the functional blocks including the stream analytical unit 2001, the video decoding unit 2002, the image processing unit 2003, the encoding unit 2004, and the stream rewriting unit 2005 so that the stream is input to the distribution processing unit 2006. Alternatively, the input stream may be directly input to the distribution processing unit 2006 without passing those functional blocks.

The distribution control unit 49 may be configured to have functional blocks including changing of the compression format (transcode, re-encode), and compressing by lowering bit rate of the recording data (translate)(explanation and the drawing will be omitted for simplification). The aforementioned process may be added to provide advantage which allows flexible implementation in accordance with user's needs.

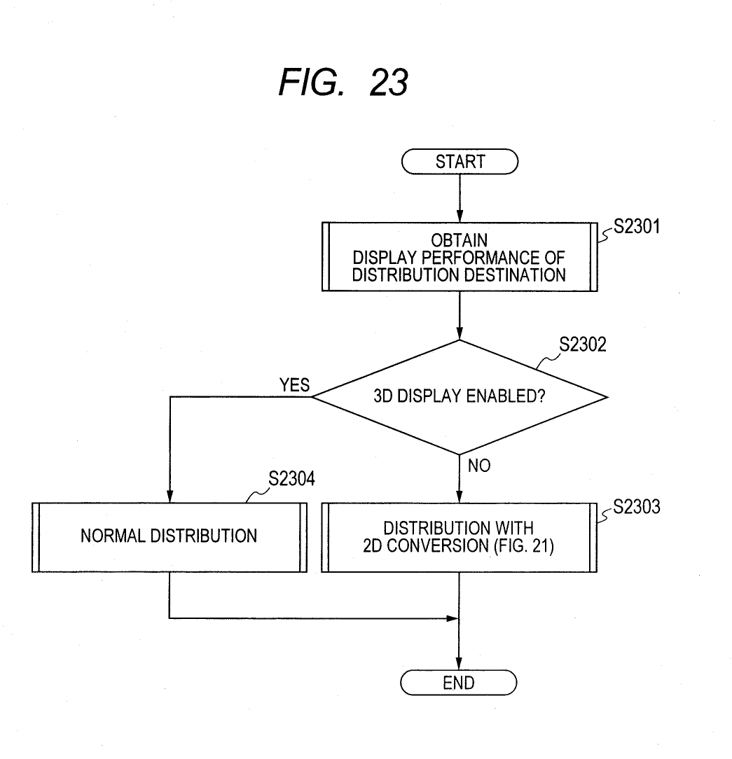

FIG. 21 shows an exemplary 2D conversion process for executing 2D conversion distribution according to the example. The network connection configuration will be described taking the one shown in FIG. 18 as an example. After starting the process, it is determined whether the conversion recording into 2D contents is executed in S2101. The detailed explanation with respect to the determination method will be described later. The determination may be made by detecting the display performance of the display device of the distribution destination for automatic selection, or presenting the GUI screen for menu setting as shown in FIG. 22 so as to allow the user to select preliminarily. Any other method may be employed.

When 2D conversion is not executed, the process proceeds to S2104 where the stream is distributed as 3D contents. The process then ends. When 2D conversion is executed, the process proceeds to S2102 where the 3D identifier of the stream is rewritten from the value indicating SBS mode into the value indicating 2D video in the stream rewiring unit 2105.

As for the data structure as described above, the value of Stereo_Video_Format_Signaling_type which exists in user_data of the picture layer in the stream as shown in FIG. 5D is rewritten from 0000011 to 0001000.

Thereafter, the process proceeds to S2103 where the process for executing 2D conversion of the stream in SBS mode is executed in accordance with the 2D conversion method as described above. In S2103, the L-side video image in SBS mode as described referring to FIG. 7 is extracted and enlarged to obtain the 2D image.

After rewriting the 3D identifier and extracting the stream of 2D video format, the process proceeds to S2104 where the stream is transmitted from the network I/F 25 to start distribution. When the distribution is completed, the process ends. Upon starting the distribution in S2104, the compression format may be changed (transcode and re-encode), compression recording (translate) may be executed by lowering the bit rate of the recording data, and realizing high definition through super-resolution technique. The aforementioned process is added to provide advantage which allows implementation in accordance with user's needs.

In the case where the compression format of the contents derived from subjecting the 3D contents in SBS mode to 2D conversion is changed from the MPEG2 to MPEG4-AVC upon distribution, the process is executed for restructuring the stream without adding Frame_packing_arrangement_SEI in accordance with the value of the identifier rewritten in S1203, or rewriting so as to be added as the appropriate value (value of frame_packing_arranngement_flag is set to 1 specified as 2D), thus providing the similar effect.

Steps S2102 and S2103 are applied to different points as results of the respective processes in the stream, and they may provide similar effects by executing those steps in reverse order. When executing conversion from 3D video image into the 2D video image, the 3D identifier may be deleted for distribution. As the data structure has compatibility with the generally employed 2D broadcasting type irrespective of no 3D identifier. So the receiver is capable of recognizing the 2D video image in spite of the deleted 3D identifier.

For the above-described example, user_data is used for the picture layer in video_sequence defined by the MPEG2 video. However, the present invention is not limited to the one as described above. For example, the program information (for example, SI, component descriptor) may be used for the method which allows rewriting or deletion of the 3D identifier defined in those data. In such a case, the stream analytical unit 2001 of the distribution control unit 49 analyzes the program information derived from the de-multiplexing unit 29 so that the data indicating the 3D identifier are rewritten or deleted from the program information in the stream rewriting unit 2005. In the aforementioned case, the 3D identifier may be directly deleted. This method allows execution of the same process using the program information without user_data of the picture layer in video_sequence.

The 3D identifier contained in the program information, for example, SI may be used simultaneously with the 3D identifier contained in user_data of the picture layer in video_sequence defined by the MPEG2 video. In such a case, the information indicating existence of the 3D video is only added to the SI so as to add the information which identifies the 3D video with the 3D method to user_data.

In the exemplary process as described above, SI with the information indicating existence of the 3D video image is deleted upon 2D conversion recording, and the information content indicating 3D method contained in user_data is rewritten or deleted. In the aforementioned case, the 3D identifier may be directly deleted. The rewriting or deleting process may employ the respective methods as described above, or any other method. Such method allows use of both the 3D identifier contained in SI and the one of user_data for more flexible processing.

In the aforementioned example, the 3D transmission mode in SBS mode has been described. However, the other mode such as TAB mode and 2-viewpoint classified ES transmission mode may be employed. With the 3D 2-viewpoint classified ES transmission mode, data of 2D display format may be obtained by deleting the sub-viewpoint ES. As for TAB mode, the video image is separated into two top and bottom sections by the image processing unit 2003, one of which is subjected to image processing such as enlarging to obtain data of 2D display format. The 2D conversion distribution is executed with the method adapted for the 3D transmission mode.

The method for determining with respect to selection of the display format (whether or not distribution is made by executing 2D conversion) will be described. When using the menu setting as shown in FIG. 22, the item “2D CONVERSION FOR DISTRIBUTION” is provided in the menu displayed on a display 2201 (2202). Upon reception of a 3D contents distribution request, the setting determines whether the conversion process (described later) is executed automatically in the receiver A (distribution source) 4.

Based on the setting preliminarily performed by the user in accordance with the menu, the receiver A (distribution source) 4 is activated. As indicated by 2203 in the drawing, the brief description of the function may be added to the menu. With the method which allows selection of the setting in reference to the screen such as the setting menu, the user is enabled to explicitly sets whether the 2D conversion distribution is executed, thus improving usability.

The other method for determining whether or not 2D conversion is executed based on the display performance of the receiver B (distribution destination) 5 for displaying upon distribution will be described. FIG. 23 shows an example of the process. After starting the process, the receiver A (distribution source) 4 obtains the display performance (hereinafter referred to as display performance information) of the receiver B (distribution destination) 5. The display performance information contains the information indicating as to which format is used for enabling the display. For example, the data contains such descriptions as “BOTH 2D/3D DISPLAY AVAILABLE” and “ONLY 2D DISPLAY IS AVAILABLE”.

The method may be realized by providing the device which obtains the display performance information through communication using such protocol as HTTP (HyperText Transfer Protocol) via LAN. The process for obtaining the display performance information is executed by the network I/F 25 and the distribution control unit 49, for example.

After obtaining the display performance information, the process proceeds to S2302 where it is determined whether the distribution destination is capable of displaying 3D image based on the description of the display performance information. The determination process is executed by the distribution control unit 49, for example. If the receiver B (distribution destination) 5 is available for 3D display, the process proceeds to S2304 where the distribution is started by keeping 3D mode while executing the normal distribution, that is, without executing the conversion process. The process then ends.

When the receiver B (distribution destination) 5 is unavailable for 3D display, that is, it is available only for the 2D display, and the 3D contents are distributed in S2302, the data cannot be displayed unless the receiver B (distribution destination) 5 is configured to be able to process 2D conversion. Although it is configured to be able to process 2D conversion, the user is required to instruct execution of 2D conversion, thus deteriorating usability. In the example, when it is determined in S2302 that the distribution destination is unavailable for 3D display, the process proceeds to S2303 where the 2D conversion is processed in the receiver A (distribution source) 4, and distribution is started. The process, then ends. The method that has been described referring to FIG. 21 may be employed as the method for executing 2D conversion distribution. The method for selecting the display format is not limited to the one as described above.

The above described method allows conversion of the 3D contents into the 2D display data in the distribution source for distribution, and eliminates the conversion process from 3D to 2D in the receiver side. Accordingly, the user who views the contents on the receiver does not have to explicitly instruct the 2D conversion, thus improving user convenience.

Especially, the method for distribution of the data through automatic 2D conversion in accordance with the display performance of the distribution destination allows display of the 2D contents although such data are distributed to the device with no 2D conversion function. The device with 2D conversion function does not have to execute conversion because of automatic 2D determination, thus simplifying the operation.

The 2D conversion distribution of the contents of 3D 2-viewpoint classified ES transmission mode may be executed by deleting unnecessary 3D stream data (ES). So size of the data transmitted to the network is reduced, resulting in advantage of reducing the usable band.

When it is found difficulty in ensuring sufficient transfer rate from a result of detecting the band for the network serving as the transmission path and communication state, the aforementioned method may be used, which allows the receiver A (distribution source) 4 to execute the 2D conversion and change the 3D identifier automatically although the receiver B (distribution destination) 5 is available for 3D video display.

There may be the case where the 2D video transmission is enabled for the network having high load communication frequently conducted, which makes it difficult to execute transmission of the 3D contents by deleting the stream data through 2D conversion as described above.

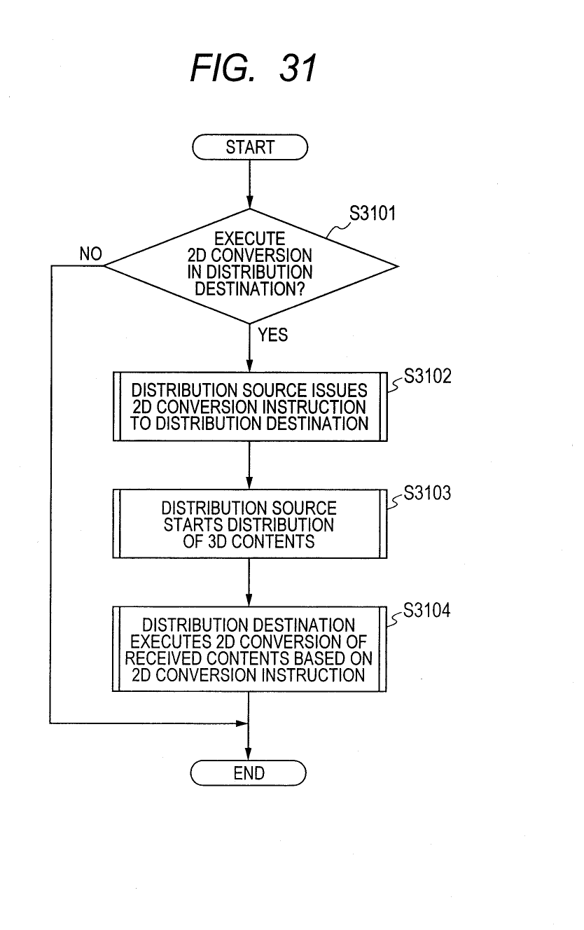

With another method, the receiver B (distribution destination) 5 may be instructed to execute 2D conversion at the timing such as starting of distribution while distributing the 3D contents. FIG. 31 represents an exemplary process for 2D conversion executed by the receiver B (distribution destination) 5 in response to the 2D conversion instruction from the receiver A (distribution source) for display.

In S3101, it is determined whether the receiver B (distribution destination) executes 2D conversion. If the 2D conversion is not executed, the process ends. It the 2D conversion is executed, the process proceeds to S3102 where the receiver A (distribution source) issues 2D conversion instruction to the receiver B (distribution destination).

There is the method for transmitting the command through communication with such protocol as HTTP via LAN, for example so that the receiver side determines the received command as the 2D conversion instruction. The process proceeds from S3102 to S3103 where the receiver A (distribution source) distributes the 3D contents without specifically changing the contents likewise the normal distribution.

The process proceeds to S3104 where the receiver B (distribution destination) displays data subjected to 2D conversion in accordance with the 2D conversion instruction. The process then ends. The method allows the receiver B (distribution destination) to execute 2D conversion, which does not require the user who views the receiver B (distribution destination) to perform the operation corresponding to the conversion instruction explicitly, thus improving usability.

The method for recording 3D contents while executing 2D conversion of the 3D contents will be described.

There may be the method that the user away from home views the broadcasted contents recorded in the receiver on another device provided with the display device and the recording medium (for example, mobile phone and game machine, hereinafter referred to as external recording device) to which the contents have been copied or moved. It is assumed that the term copy denotes duplication of the contents (file) to the other device and another recording medium while keeping the original contents, and the term move denotes movement of the contents (file) to the other device and another recording medium without keeping the original contents.

In such a case, it may be necessary to execute video format conversion conforming to the display performance of the external recording device as the destination of copy/move. For example, in the case where the external recording device as the copy destination has the display device capable of displaying with normal image quality (displaying 640×480 pixels at field angle), which is expected to receive full high vision contents 1920×1080 pixels at field angle) transmitted through digital broadcasting, the external recording device is not able to reproduce quality of the contents completely, or may fail to display.

So there is the method for converting quality of the contents into normal one (down conversion) preliminarily or simultaneously with copy/move from the receiver to the external recording device. The method allows the contents to be displayed by the device as the copy destination conforming to the resolution of the external recording device, thus preventing unnecessary increase in the file size.

Besides the quality, there may be differences in available codec, frame rate, and progressive/interlace between the receiver and the external recording device in which the copy/move is conducted. Conversion in accordance with the aforementioned differences may be necessary.

When 3D contents are recorded in the receiver, and moved/copied to the external recording device, the device as the copy/move destination may fail to display the 3D video image in spite of the codec and quality at the same level. Assuming that the data of 3D contents with full high vision quality in SBS mode, which are compressed through MPEG2 are copied/moved, such data need to be 2D converted so as to be copied/moved to the device which cannot display the 3D contents in SBS mode.

Upon viewing of the 3D contents, if codec and resolution of the 3D contents to be viewed are at the same level as those of the device for displaying the data, it is possible to reproduce the 3D contents as the 2D contents. In such a case, however, upon reproduction of the 3D contents in SBS mode as the 2D contents, the resultant display may fail to satisfy display requirement expected by the distribution source of the contents. The method of executing the 2D conversion recording is required by determining with respect to availability for the 3D contents.

Upon reception of broadcasting with 3D contents, the 3D contents and 2D contents obtained by converting the 3D contents are recorded in consideration of copy/move to the external recording device so that the preliminarily converted 2D contents may be copied/moved.

The method requires no 2D conversion when the contents are copied/moved to the external recording device by the user, and reduces the time taken for such conversion process, thus improving user usability.

The 2D conversion recording may be executed when copying/moving the 3D contents that have been recorded in the recording medium of the receiver once likewise dubbing as described in Example 1. In this case, copy right protection has to be appropriately applied to the copy control. However, the example is applicable to any type of the copy control method, and explanation thereof, thus will be omitted.

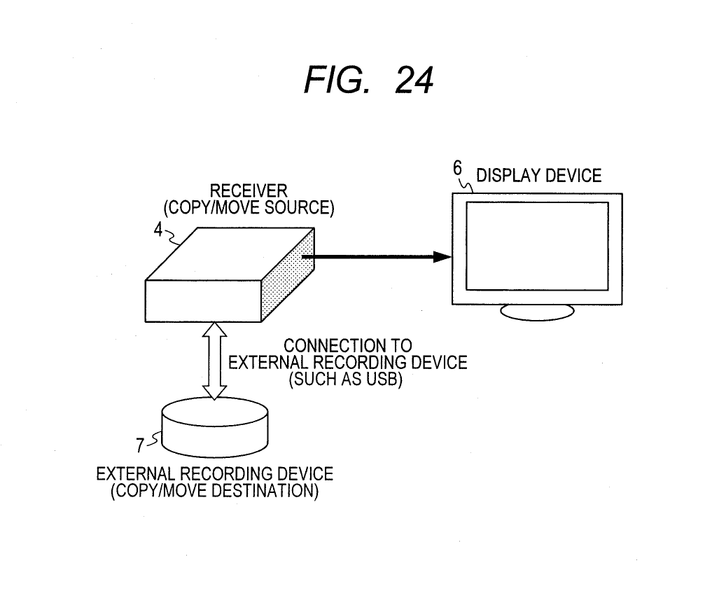

FIG. 24 shows an exemplary configuration of an external recording device 7 to which the contents are copied/moved, and the receiver 4. The receiver 4 likewise the one as described above is a device capable of recording the received broadcast that contains 3D contents. The external recording device 7 is distinct from the receiver 4, which is formed as the mobile phone and the game machine provided with the recording medium such as HDD and flash memory, and the external recording medium which are removable and portable for the use. The display device 6 is structured to display the video image of contents of the receiver 4 on the display unit. The receiver 4 and the display device 6 may be combined together. The external recording device 7 may be or may not be provided with the display device.

Referring to FIG. 24, an external recording device connection terminal of the receiver 4 (for example, USB: Universal Serial Bus) of the receiver 4 is connected to the similar terminal of the external recording device 7 using the corresponding cable so that the contents received and recorded by the receiver 4 are allowed to be copied or moved to the external recording device 7.

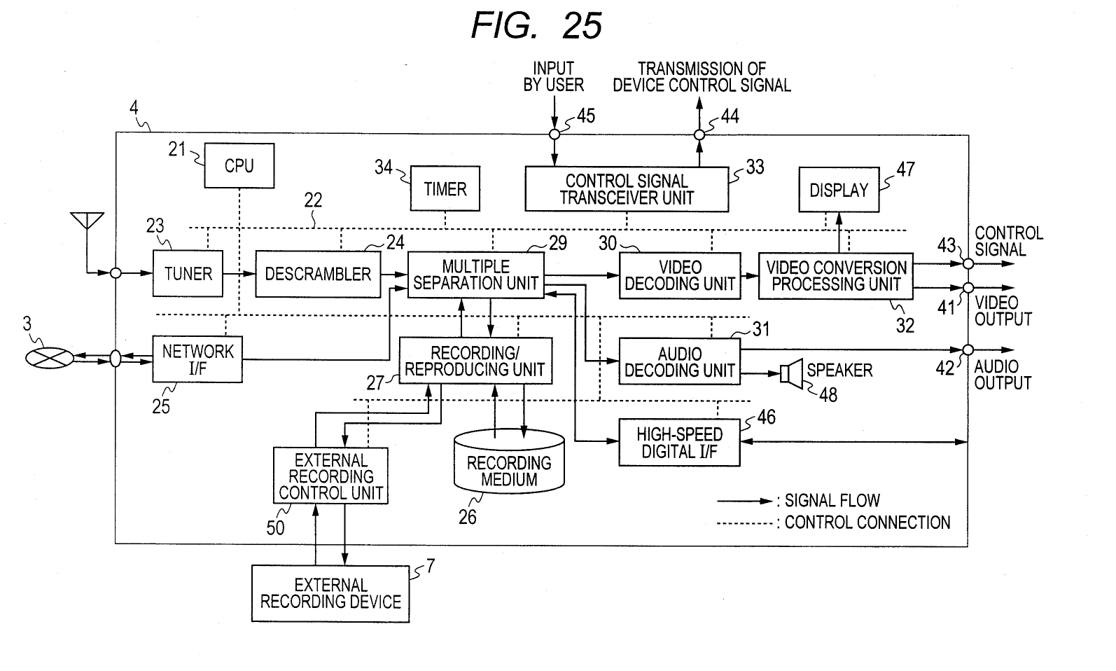

FIG. 25 shows an exemplary functional block diagram of the receiver 4 according to the example. An external recording control unit 50 executes control relevant to recording of the data to the external recording device 7, for example, converting the data read by the recording/reproducing unit 27 from the recording medium 26 into the format recordable by the external recording device 7. The external recording device 7 is similar to the one described referring to FIG. 24 (the method for recording within the external recording device 7 is not specifically limited in this example, and explanation thereof, thus will be omitted). The other functional blocks are the same as those described referring to FIG. 13.

FIG. 25 shows bilateral signal (data) flow among the external recording device 7, the external recording control unit 50, and the recording/reproducing unit 27. This indicates possibility of copy/move from the receiver 4 to the external recording device 7 or vice versa. The structure with one-way signal flow from the receiver 4 to the external recording device 7 has no problem in application of the example.

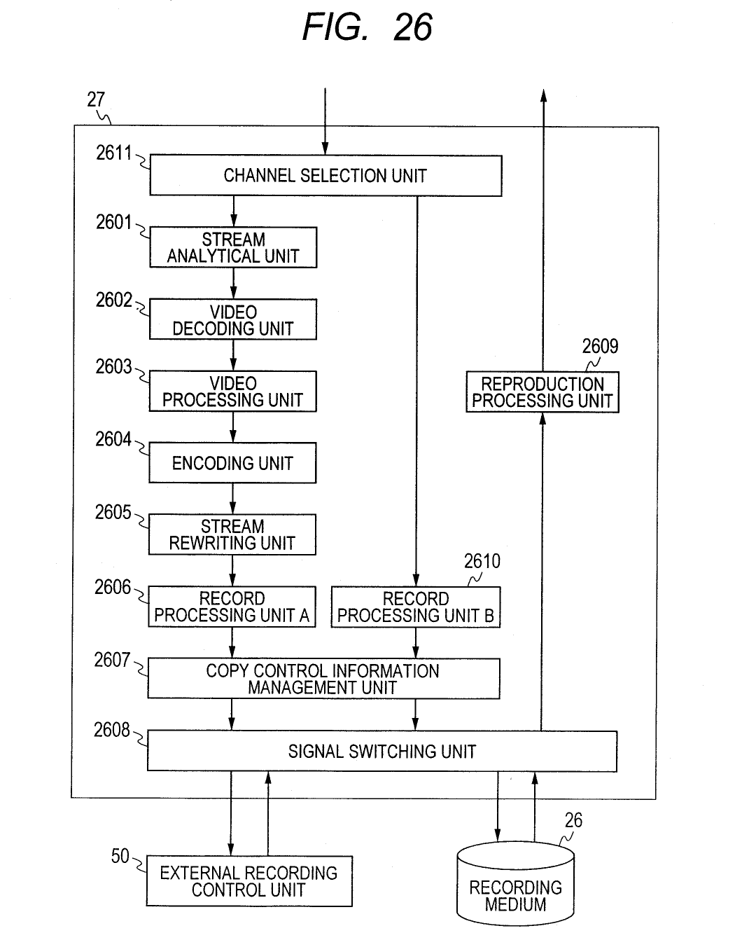

FIG. 26 shows exemplary functional blocks of the recording/reproducing unit 27 which allows recording of the 3D broadcast contents and 2D conversion recording. The recording/reproducing unit 27 will be described.

A stream analytical unit 2601 analyzes the input stream, and obtains internal data such as the 3D identifier. The content of the data multiplexed with the stream such as the program information may be obtained.

A video decoding unit 2602 decodes the video data of the input stream. This is the decoding unit mainly used for executing the image processing, which is functionally different from the video decoding unit of the receiver 4. However, such unit may be used for video decoding in the normal operation. An image processing unit 2603 executes image processing, for example, separating the video data derived from the video decoding unit 2602 into two left and right sections, and enlarging the video data at a predetermined field angle.

An encoding unit 2604 encodes the video data derived from the image processing unit 2603 to the format for recording by the recording medium.

A stream rewiring unit 2605 rewrites the data contained in the stream such as the 3D identifier. The 3D identifier as described above (see FIGS. 5A to 5D) may be the data to be rewritten in the example. The unit further executes re-multiplexing of the video data processed in the aforementioned block, the audio data and the other control data. If the format of the stream to be distributed is the MPEG2-TS, re-multiplexing is executed to achieve the format.

A recording processing unit A 2606 accesses the recording medium 26 and the external recording control unit 50, and writes the data. A copy control information management unit 2607 manages management information under the copy control of the contents to be recorded for restricting the frequency of copying so as to protect copyright.

A signal switching unit 2608 switches the operation among recording of the stream data of the object contents in the recording medium 26, recording of the data in the external recording device 7 via the external recording control unit 50, and recording of the data in both devices, and further switches the reproduction path depending on the contents to be reproduced between the recording medium 26 and the external recording device 7.

A reproduction processing unit 2609 reproduces contents from the recording medium 26 or the external recording device 7. The signal switching unit 2608 may be used to select the device between the recording medium and the external recording device as the source of the contents to be recorded. A channel selection unit 2611 sorts the stream data of the contents to be recorded into the channel for recording 3D contents and the channel for executing 2D conversion recording. The stream is input to any one of or both channels capable of recording the normal 3D contents (recording processing unit B 2610) and executing 2D conversion recording (channel from stream analytical unit 2601 to the stream rewriting unit 2605).

It is possible not to subject the stream which passes the channel capable of executing the 2D conversion recording to the 2D conversion processing. In this case, the stream may be input to the recording processing unit A 2606 for recording while passing functional blocks including the stream analytical unit 2601, the video decoding unit 2602, the image processing unit 2603, the encoding unit 2604, and the stream rewiring unit 2605. The input stream may be directly input to the recording processing unit A 2606 without passing all those functional blocks. The order for connecting those functional blocks as shown in the drawing is a mere example. No problem occurs even if the order is changed.

The recording reproducing unit 27 may be configured to have the functional blocks for executing decoding of cipher, changing compression format (transcode and re-encode), executing compression recording (translate) by lowering the bit rate of the recorded data, and executing high definition using the super-resolution technology (explanation and drawing will be omitted for simplification).

Those functional blocks may be installed as hardware or as the module formed of software. The recording/reproducing unit 27 is controlled by the recording/reproducing control unit 58 as the functional module in the CPU 21. The respective functional modules in the recording/reproducing unit 27 may be automatically or individually operated.

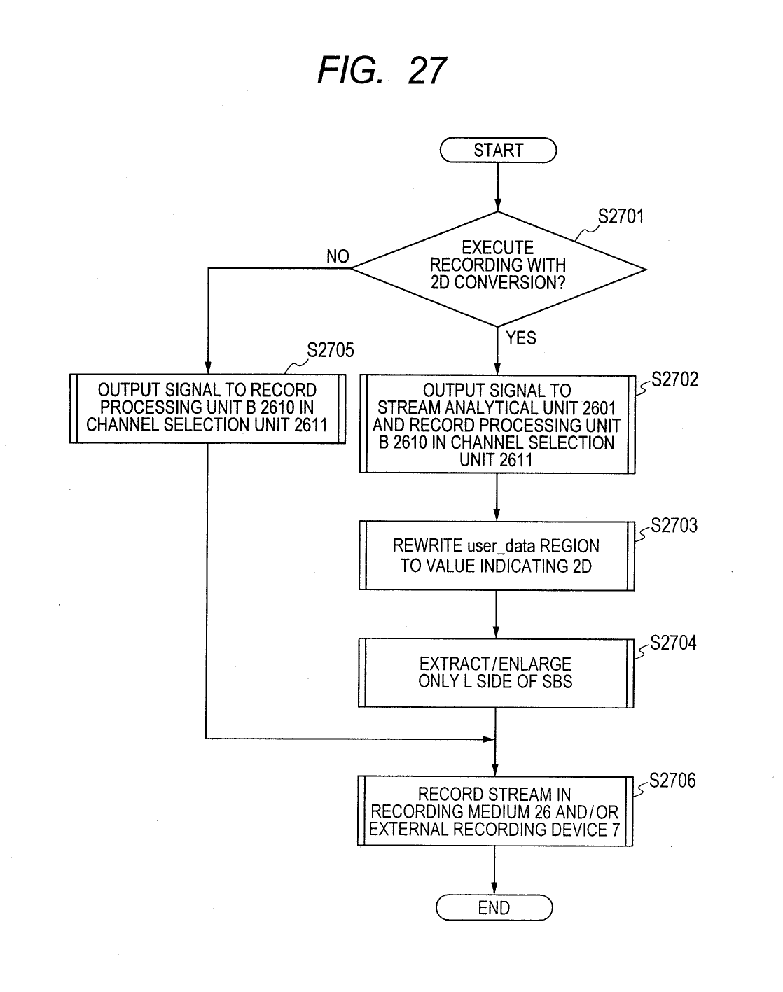

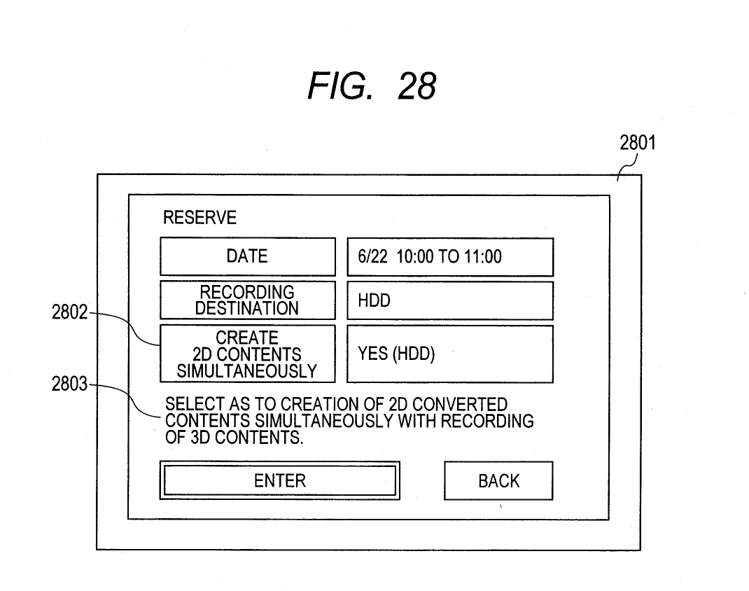

FIG. 27 shows an exemplary 2D conversion recording process simultaneously with recording of 3D contents in the example. After starting the process, it is determined in S2701 whether the 2D conversion recording is executed simultaneously with recording of 3D contents. The detailed explanation with respect to the determination method will be described later. The determination may be made by detecting the display performance of the connected external recording device 7 for automatic selection, or presenting the GUI screen for menu setting as shown in FIG. 28 so as to allow the user to select. Any other method may be employed.

When 2D conversion is not executed, the process proceeds to S2705 where the channel selection unit 2611 is controlled to output the signal to the recording processing unit B 2610 as the channel where the 2D conversion is not executed by the recording/reproducing unit 27. Thereafter, the process proceeds to S2706 where the 3D contents of the received broadcasting are recorded in the recording medium 26 and/or the external recording device 7 as the stream through execution performed by the recording processing unit B 2610 and the copy control information management unit 2607. Then process, then ends.

Detailed explanation with respect to the method for selecting the recording destination will be described later. The signal switching unit 2608 is capable of selecting any one of or both recording destinations. For example, the 3D contents may be directly recorded in the connected external recording device 7 which is available for the 3D display.

When executing the 2D conversion recording, the process proceeds to S2702 where the channel selection unit 2611 is controlled to output the stream data to both the stream analytical unit 2601 as the channel for executing the 2D conversion and the recording processing unit B 2610 as the channel for executing the normal 3D recording. Thereafter, the process proceeds to S2703 where the stream rewiring unit 105 rewrites the 3D identifier of the stream from the value indicating SBS mode to the value indicating 2D video image.

As for the data structure as described above, the value of Stereo_Video_Format_Signaling_type shown in FIG. 5D, which exists in user_data of the picture layer in the stream is rewritten from 0000011 to 0001000.

Thereafter, the process proceeds to S2704 for executing 2D conversion of the stream in SBS mode in accordance with the 2D conversion method as described above. In S2704, the L-side video image in SBS mode as described referring to FIG. 7 is extracted and enlarged to obtain the 2D image.

After rewriting the 3D identifier and extracting the stream in 2D video format, the process proceeds to S2706 where the stream is recorded in the recording medium 26 and/or the external recording device 7. The process then ends. Upon recording in S2706, the compression format may be changed (transcode and re-encode), compression recording is executed (translate) by lowering the bit rate, and realizing high definition through super-resolution technique. The aforementioned processes are added to provide advantage which allows implementation in accordance with user's needs.

In the case where the compression format of the contents derived from subjecting the 3D contents in SBS mode to 2D conversion is changed from the MPEG2 to MPEG4-AVC upon recording, the process is executed for restructuring the stream without adding Frame_packing_arrangement_SEI in accordance with the value of the identifier rewritten in S2703, or rewriting so as to be added as the appropriate value (setting the value of frame_packing_arrangement_flag to 1 specified as 2D, thus providing the similar effect.

Steps S2703 and S2704 are applied to different points as results of the respective processes in the stream, and they may provide similar effects by executing those steps in reverse order. When executing conversion from 3D video image into the 2D video image, the 3D identifier may be deleted. As the data structure has compatibility with the generally employed 2D broadcasting type irrespective of no 3D identifier. So the receiver is capable of recognizing the 2D video image although the 3D identifier is deleted.

The aforementioned example has been described, taking user_data of the picture layer in video_sequence defined by the MPEG2 video as the example. However, the present invention is not limited to the one as described above. For example, the program information (for example, SI, component descriptor) may be used for the method which allows rewriting or deletion of the 3D identifier defined in those data. In such a case, the stream analytical unit 2601 of the recording/reproducing unit 27 analyzes the program information derived from the de-multiplexing unit 29 so that the data indicating the 3D identifier is rewritten or deleted from the program information. The 3D identifier may be directly deleted. This method allows execution of the same process using the program information without user_data of the picture layer in video_sequence.

The 3D identifier contained in the program information, for example, SI may be used simultaneously with the 3D identifier contained in user_data of the picture layer in video_sequence defined by the MPEG2 video. In such a case, the SI with the information indicating existence of the 3D video is deleted, and the information content indicating the 3D mode contained in user_data is rewritten or deleted.

In the aforementioned case of deletion, the 3D identifier may be directly deleted. The rewriting or deleting process may employ the respective methods as described above, or any other method. Such method allows use of both the 3D identifier contained in the SI and the one of user_data for more flexible processing.

In the aforementioned example, the 3D transmission method in SBS mode has been described. However, other mode such as 3D 2-viewpoint classified ES transmission mode and TAB mode may be employed. The 3D 2-viewpoint classified transmission mode provides the data with 2D display format by deleting the sub-viewpoint ES. For example, in the TAB mode, the image processing unit 2603 separates the image into two top and bottom sections, one of which is subjected to the image processing, for example, enlarging at a predetermined field angle to provide the data with 2D display format. The 2D conversion recording is executed with the method adapted for the corresponding 3D transmission mode.

The method for determining execution of the 2D conversion recording simultaneously with recording of 3D contents will be described. When using the screen as shown in FIG. 28, the item “CREAT 2D CONTENTS SIMULTANEOUSLY” is provided on the screen for recording reservation (2802). This setting establishes the determination to execute the 2D conversion recording simultaneously with recording of the 3D contents. With the method, the 2D conversion recording is executed based on the setting which has been preliminarily established by the user upon recording reservation.

The aforementioned method enables the user to determine execution of the 2D conversion recording for each recording reservation of the contents, resulting in improved usability. As indicated by 2803 in the drawing, the brief description of the function may be added to the menu.

In addition to the recording reservation screen, default values are set for the menu so that the 2D conversion recording is executed based on the preliminary setting without requiring the user to select with each cycle. The method for selecting the setting from the menu on the screen allows the user to explicitly set whether the 2D conversion distribution is executed simultaneously with recording of 3D contents, resulting in improved usability.

As for another example which allows the external recording control unit 50 to obtain the display performance of the external recording device 7, the method for automatically executing the 2D conversion recording (without user's operation) may be considered in the case where the external recording device is unavailable for the display of 3D video image. With the aforementioned method, the 2D conversion recording is automatically executed in accordance with the external recording device while having the user unaware of the external recording device connected to the receiver (with no specific operation), resulting in improved usability.

Described is the method for selecting the recording destination of the 2D contents obtained through conversion upon 2D conversion recording simultaneously with recording of 3D contents. The recording/reproducing unit 27 allows the signal switching unit 2608 to execute signal outputs to the recording medium 26 within the receiver 4 and to the external recording device 7 connected to the receiver 4 (via the external recording control unit 50).

This makes it possible to select the recording destination of the 3D contents and the 2D contents obtained through 2D conversion arbitrarily. The channel selection unit 2611 allows selection of the channel to which the signal is output from any one or both of the channel for the 2D conversion recording and the normal recording channel (3D contents are kept unchanged). There may be the method for recording both the 3D contents expected to be recorded and the 2D contents obtained through 2D conversion in the recording medium 26.

This method provides the effect of enabling the 2D conversion recording even if the external recording device 7 is not connected. The method for directly recording the 2D contents obtained through 2D conversion in the external recording device 7, and recording the 3D contents in the recording medium 26 may be selected as another method in the case where the external recording device is connected.

The method allows direct writing of the contents to be finally copied/moved to the external recording device 7, thus reducing the operation procedures of the user, resulting in improved usability.

It is possible to provide the method for recording the 2D converted 2D contents in both the recording medium 26 and the external recording device 7 simultaneously by branching the same signal to the respective outputs, which is performed by the signal switching unit 2608 as well as the method for recording the 3D contents in both the recording medium 26 and the external recording device 7 simultaneously while having the 3D contents kept in the original state without executing 2D conversion. This may provide the advantage of arbitrary implementation in accordance with the user's needs or the adopted technique for protecting copyright.

In this example, handling of the contents upon dubbing when copyright protection is applied under the copy control having the frequency restricted will be described. In the example, the concept of copy and move is generally referred to as dubbing. There may the method of managing the copy control information upon dubbing, which is executed by the copy control information management unit 2607, for example.

In the case where a plurality of dubbing operations are allowed, for example, dubbing 10 (9 times for copying, once for moving), and there are remaining number of times for dubbing, the dubbing by once is allocated to the 2D conversion contents. Specifically, if the recording of 3D contents executed once and 2D conversion contents executed once, originally, the remaining number of times for dubbing of the 3D contacts are 8 times for copying and once for moving. The 2D contents obtained through 2D conversion will be counted as the dubbed contents. So the move only becomes available.

In the method which allows the dubbing only once (copy once, move once), the dubbing frequency is allocated to the 2D conversion contents. Specifically, the 3D contents recording is executed once, and the 2D conversion recording is simultaneously executed once. The dubbing of the 3D contents is executed once. So the move only becomes available. The 2D contents are handled as the dubbed contents, thus making only the move available.

When the 2D conversion is simultaneously executed with respect to the contents subjected to inhibition of copying. If both the 3D contents and the 2D contents through 2D conversion allow 2D contents to be viewable, it is not preferable because of existence of the copy. So one of those contents is made viewable.

There may be the method which conceals one of 3D contents and 2D converted 2D contents which are recorded in the recording medium 26 so as not to be accessed by the user by switching the accessible contents through the menu setting.

In such a case, if the 2D converted contents are recorded in the external recording device 7, and original 3D contents are recorded in the recording medium 26 within the receiver 4 for mobile purpose, it is not appropriate to make those contents viewable from both the external recording device 7 and the receiver 4.

Upon selection of the above-described recording method, the copy control information management unit 260 may be used to control so that the 3D contents recorded in the recording medium 26 are made inaccessible. There may also be the method to make the original 3D contents in the recording medium 26 within the receiver 4 accessible by detecting deletion of the 2D converted 2D contents of the external recording device 7 under the control of the copy control information management unit 2607. The receiver 4 may be structured to detect deletion of the 2D contents recorded in the external recording device 7 upon such deletion. Alternatively, the deletion may be detected when the external recording device 7 and the receiver 4 are connected.

In the case where the contents are taken out from the receiver to the external device such as a mobile phone that is only available for 2D video image, the data may be preliminarily subjected to 2D conversion recording simultaneously with recording of the original 3D contents so that dubbing is easily conducted. It is possible not only to execute 2D conversion recording simultaneously in accordance with display performance but also to reduce the time taken for dubbing to the external recording device using the effect resulting from reduced data size through 2D conversion. In the case where the user does not want the 3D display of the contents to be recorded in the external recording device, the data capacity occupied by the contents and the dubbing time may further be reduced, resulting in improved convenience for the use.

What is claimed is:

1. A receiver which receives a digital broadcasting signal, comprising:
a receiver unit which receives the digital broadcasting signal with contents that include a video signal and identifier information indicating that the video signal includes a 3D video signal;
a conversion unit which converts the 3D video signal into a 2D video signal;
a rewriting unit which rewrites or deletes the identifier information; and
a distribution processing unit capable of transmitting the contents contained in the digital broadcasting signal received by the receiver unit to other device, wherein:
the conversion unit converts the 3D video signal contained in the contents into the 2D video signal; and
the rewriting unit rewrites or deletes the identifier information contained in the contents when the distribution processing unit performs distribution to the other device.

2. The receiver according to claim 1, further comprising:
a display performance information obtaining unit which obtains data that contain display performance information, based on which a video format that allows the other device to display is identified; and
a conversion determination unit which determines whether or not the 3D video signal is converted into the 2D video signal based on the display performance information, wherein:
when distribution is performed from the distribution processing unit to the other device, the conversion determination unit determines whether or not the 3D video signal is converted into the 2D video signal based on the display performance information obtained by the display performance information obtaining unit;
if it is determined to distribute the converted 2D video signal, the rewriting unit rewrites or deletes the identifier information of the contents.

3. A receiver which receives a digital broadcasting signal, comprising:
a receiver unit which receives the digital broadcasting signal with contents that include a video signal and identifier information indicating that the video signal includes a 3D video signal;
a conversion unit which converts the 3D video signal into a 2D video signal;
a control unit which controls the identifier information;
a recording unit capable of recording the contents contained in the digital broadcasting signal received by the receiver unit in a recording medium; and
an external recording device connection unit capable of connecting other external recording device, wherein:
the recording unit records the broadcasting contents received by the receiver unit in the recording medium; and
the conversion unit converts the 3D video signal of the contents into the 2D video signal to rewrite or delete the identifier information of the converted contents.

4. The receiver according to claim 3, wherein the 2D video signal converted by the conversion unit is output to the external recording unit connected to the external recording device connection unit.
